(19) United States
(12) Patent Application Publication
(10) Pub. No.: US 2026/0350834 A1
(43) Pub. Date: Nov. 5, 2026

(54) LOCATION CORRELATION OF ROAD SURVEY DATA ACROSS MULTIPLE SURVEY TIME INSTANCES

(71) Applicant: FNV IP B.V., Leidschendam (NL)

(72) Inventors: Kevin Anthony NORMAND, Broussard, LA (US); Matthew John CONNELLY-TAYLOR, Ontario (CA); Shahriar Mahmud NINAD, Ontario (CA); Ruben-Elisei CONSTANTIN, Craiova (RO); Michael Joseph BLANCHARD, Broussard, LA (US)

(73) Assignee: FNV IP B.V., Leidschendam (NL)

(21) Appl. No.: 19/195,562

(22) Filed: Apr. 30, 2025

(51) Int. Cl. G06T 7/73; G01C 21/00; G06F 16/29; G06V 10/75; G06V 20/56

(52) U.S. Cl. CPC G06T 7/74; G01C 21/3815; G01C 21/3841; G06F 16/29; G06V 10/751; G06V 20/588; G06T 2207/30256

(57) ABSTRACT

A first and second set of road survey data frames can be obtained for a first and second series of measurement locations along a length of a road surface. The first and second sets of road survey data frames can correspond to respective first and second road surveys at respective first and second times. Based on location correlation information determined between the first and second sets of road survey data frames, selected portions of the first and second sets of road survey data frames can be determined corresponding to a requested viewpoint along the length of the road surface. The selected portions of the first and second sets of road survey data frames can be output for display. Unlocking insights from geodata, the present disclosure further relates to improvements in sustainability and environmental developments: together we create a safe and liveable world.

### FIELD

Aspects of the present disclosure generally relate to road surveying. For example, aspects of the present disclosure are related to determining and using location correlation information between road survey data obtained for a length of road surface across multiple road survey instances acquired at different times and/or years. Unlocking insights from geodata, the present disclosure further relates to improvements in sustainability and environmental developments: together we create a safe and liveable world.

### BACKGROUND

A survey mechanism can refer to a device or system used for conducting surveys or collecting data in various fields such as land surveying, geographic information systems (GIS), construction, environmental monitoring, and scientific research. Some examples of pavement surveying operations (e.g., also referred to as road surveying and/or road profiling, etc.) can be performed using a vehicle with an integrated or attached surveying mechanism with one or multiple onboard sensors configured to perform measurements and/or collect data associated with one or more features and/or characteristics of a road. The features and/or characteristics of the road may correspond to the road surface, the road sub-surface, and/or various combinations thereof. In some examples, the surveying mechanism can be integrated on or within a vehicle, which may be used to collect data regarding a topography and texture of pavement, as the vehicle is used to perform a road survey along a length of road surface. For example, the vehicle can drive or otherwise travel the length of road surface while using the multiple sensors to perform measurements and data collection corresponding to the road survey data. In some examples, the vehicle can perform the road survey by traveling (e.g., driving) upon the road surface of each of a plurality of road segments specified for inclusion in the road surveying operation(s). Road and pavement surveys can provide valuable insights into the need to repair cracks or potholes in the pavement and can be used to characterize the pavement condition at the time of the survey.

In some examples, multiple road surveys may be performed for a given portion or length of road surface or pavement. For example, a length of road surface may be surveyed at a periodic interval, such as one survey every year, every two years, every five years, etc. Conducting multiple road surveys can be used to evaluate the pavement condition over time, for example including detecting degradation in the pavement condition over time, including detection of newly formed cracks, potholes, or other defects, as well as detection or characterization of expansion and further degradation of existing cracks, potholes, etc., that were previously present in the road surface. Management of pavement condition and associated roadway assets may be based on an understanding or knowledge of how the pavement and roadway assets are performing over time. The performance over time for pavement and related roadway assets may correspond to the pavement condition over time, with better performance associated with fewer observed degradations, cracks, potholes, etc., as the pavement ages, typically over multiple years. Individual road surveys can be performed to collect large volumes of data that characterize or represent various features and characteristics of the pavement surface along the length of the road survey track (e.g., the length of surveyed road surface), with various granularities and sensor modalities used to provide further dimension to the individual road survey datasets.

Based on pavement and roadway assets being installed for service lives of multiple years, or in some cases decades, modeling the previous and future performance of pavement assets is based on multi-year analyses and comparisons between multiple different individual road survey datasets, such as the respective road survey datasets obtained for multiple previous years for a road that is surveyed annually, bi-annually, etc. Similar requirements to periodic analyses of linear infrastructure exist in, for example, track inspection for trains, metros, trams, pipeline inspections, energy grid inspections, or corridor inspections, such as tunnels, vegetation analysis, overhead power line inspections, or the like. Accurately referencing linear infrastructure survey datasets, such as road survey datasets and/or individual road survey data frames for particular measurement locations, and performing such references based on comparisons across multiple different years of respective road survey datasets, can be a cumbersome and time-consuming process. For example, manually referencing datasets from multiple years and/or road survey collection cycles, for the same asset and at the same location, may require finding the correct matching images across years, as well as accounting for changes in the survey conditions (e.g., such as changes in angle, lighting, and identifying changes between road survey images or data frames from different years as being due to circumstantial change in conditions or a true underlying change of the pavement condition of the road, etc.).

There is thus a need for systems and techniques for improved correlation, visualization, and/or analysis of road survey data acquired for different road surveys with different acquisition times.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In one illustrative example, a method can include: obtaining a first set of road survey data frames corresponding to a first series of measurement locations along a length of a road surface, the first set of road survey data frames associated with a first road survey performed at a first time; obtaining a second set of road survey data frames corresponding to a second series of measurement locations along the length of the road surface, the second set of road survey data frames associated with a second road survey performed at a second time; determining location correlation information between one or more frames of the first set of road survey data frames and one or more frames of the second set of road survey data frames; receiving a user input indicative of a requested viewpoint along the length of the road surface; determining, based on the requested viewpoint and the location correlation information, selected portions of the first and second sets of road survey data frames corresponding to the requested viewpoint; and outputting for display the selected portions of the first and second sets of road survey data frames.

In some aspects, the location correlation information is indicative of a plurality of mappings between the first set of road survey data frames and the second set of road survey data frames, and each mapping of the plurality of mappings is based on correlating the first series of measurement locations with the second series of measurement locations.

In some aspects, each mapping of the plurality of mappings includes a location reference between a respective first frame included in the first set of road survey data frames and a respective second frame included in the second set of road survey data frames; and the respective second frame for each mapping is selected from the second set of road survey data frames based on maximizing a correlation between measurement locations corresponding to the respective first and second frames.

In some aspects, each respective frame of the first set of road survey frames is associated with a respective mapping to a selected frame of the second set of road survey frames; and the selected frame of the second set of road survey frames is selected to minimize a difference in measurement location between the selected frame of the second set and the respective frame of the first set.

In some aspects, the location correlation information includes pre-determined mappings between each frame of the first set of road survey data frames to a selected frame of the second set of road survey data frames; the pre-determined mappings are stored in a database; and determining the location correlation information includes retrieving one or more of the pre-determined mappings from the database.

In some aspects, the location correlation information is associated with a configured coordinate system different from an acquisition coordinate system used for the first and second sets of road survey data frames; and determining the location correlation information includes normalizing the first and second series of measurement locations from the acquisition coordinate system to the configured coordinate system.

In some aspects, the location correlation information is determined based on comparing normalized first measurement locations of the first set of road survey data frames with normalized second measurement locations of the second set of road survey data frames to identify maximum correlation pairs of data frames across the first and second sets.

In some aspects, the location correlation information includes a respective location correlation for each road survey data frame of the first set of road survey data frames, the respective location correlation indicative of a selected road survey data frame from the second set of road survey data frames with a nearest measurement location to the road survey data frame of the first set.

In some aspects, the outputting for display includes: outputting a simultaneous side by side view of the selected portion of the first set of road survey data frames and the selected portion of the second set of road survey data frames, wherein the selected portion of the first set of road survey data frames is aligned to the requested viewpoint based on the location correlation information, and wherein the selected portion of the second set of road survey data frames is aligned to the requested viewpoint based on the location correlation information.

In some aspects, the location correlation information is determined based at least in part on one or more of the requested viewpoint or a portion of the user input.

In another illustrative example, an apparatus is provided. The apparatus includes at least one memory and at least one processor coupled to the at least one memory and configured to: obtain a first set of road survey data frames corresponding to a first series of measurement locations along a length of a road surface, the first set of road survey data frames associated with a first road survey performed at a first time; obtain a second set of road survey data frames corresponding to a second series of measurement locations along the length of the road surface, the second set of road survey data frames associated with a second road survey performed at a second time; determine location correlation information between one or more frames of the first set of road survey data frames and one or more frames of the second set of road survey data frames; receive a user input indicative of a requested viewpoint along the length of the road surface; determine, based on the requested viewpoint and the location correlation information, selected portions of the first and second sets of road survey data frames corresponding to the requested viewpoint; and output for display the selected portions of the first and second sets of road survey data frames.

In another illustrative example, a non-transitory computer-readable storage medium comprising instructions stored thereon which, when executed by at least one processor, causes the at least one processor to: obtain a first set of road survey data frames corresponding to a first series of measurement locations along a length of a road surface, the first set of road survey data frames associated with a first road survey performed at a first time; obtain a second set of road survey data frames corresponding to a second series of measurement locations along the length of the road surface, the second set of road survey data frames associated with a second road survey performed at a second time; determine location correlation information between one or more frames of the first set of road survey data frames and one or more frames of the second set of road survey data frames; receive a user input indicative of a requested viewpoint along the length of the road surface; determine, based on the requested viewpoint and the location correlation information, selected portions of the first and second sets of road survey data frames corresponding to the requested viewpoint; and output for display the selected portions of the first and second sets of road survey data frames.

In one illustrative example, a method can include: obtaining a first set of road survey data frames corresponding to a first series of measurement locations along a length of a road surface, the first set of road survey data frames associated with a first road survey performed at a first time; obtaining a second set of road survey data frames corresponding to a second series of measurement locations along the length of the road surface, the second set of road survey data frames associated with a second road survey performed at a second time; and determining location correlation information between the first set of road survey data frames and the second set of road survey data frames, wherein the location correlation information is indicative of a plurality of mappings between respective frames of the first set and respective frames of the second set according to correlations calculated for the first and second series of measurement locations.

In some aspects, the first set of road survey data frames include measurements indicative of a first set of road features corresponding to characteristics of the road surface at the first time, and wherein the second set of road survey data frames include measurements indicative of a second set of road features corresponding to characteristics of the road surface at the second time.

In some aspects, the method further includes identifying, within a first frame of the first set of road survey data frames, a first representation of a particular feature from the first set of road features; identifying, within a selected frame included in the second set of road survey data frames and mapped to the first frame based on the location correlation information, a second representation of the particular feature, the second representation included in the second set of road features; and comparing the first representation with the second representation to determine feature difference information between the first road survey and the second road survey.

In some aspects, the location correlation information is determined based on minimizing an alignment difference between a first representation of a particular feature from the first set of road features and a second representation of the particular feature included in the second set of road features.

In some aspects, the method further includes validating the location correlation information based on the feature difference information being within a configured threshold.

In some aspects, the method further includes determining the feature difference information exceeds a configured threshold; and generating a notification indicative of a request for user review to validate or invalidate one or more of the location correlation information or the feature difference information.

In some aspects, the method further includes: determining one or more shared road features included in the first set of road features and the second set of road features; for each shared road feature of the one or more shared road features, calculating first feature metrics for representations of the shared road feature in the first set of road survey data frames, and calculating second feature metrics for representations of the shared road feature in the second set of road survey data frames; and generating information indicative of one or more feature changes between the first road survey at the first time and the second road survey at the second time, the one or more feature changes based on a difference between the calculated first and second feature metrics.

In another illustrative example, an apparatus is provided. The apparatus includes at least one memory and at least one processor coupled to the at least one memory and configured to: obtain a first set of road survey data frames corresponding to a first series of measurement locations along a length of a road surface, the first set of road survey data frames associated with a first road survey performed at a first time; obtain a second set of road survey data frames corresponding to a second series of measurement locations along the length of the road surface, the second set of road survey data frames associated with a second road survey performed at a second time; and determine location correlation information between the first set of road survey data frames and the second set of road survey data frames, wherein the location correlation information is indicative of a plurality of mappings between respective frames of the first set and respective frames of the second set according to correlations calculated for the first and second series of measurement locations.

In another illustrative example, a non-transitory computer-readable storage medium comprising instructions stored thereon which, when executed by at least one processor, causes the at least one processor to: obtain a first set of road survey data frames corresponding to a first series of measurement locations along a length of a road surface, the first set of road survey data frames associated with a first road survey performed at a first time; obtain a second set of road survey data frames corresponding to a second series of measurement locations along the length of the road surface, the second set of road survey data frames associated with a second road survey performed at a second time; and determine location correlation information between the first set of road survey data frames and the second set of road survey data frames, wherein the location correlation information is indicative of a plurality of mappings between respective frames of the first set and respective frames of the second set according to correlations calculated for the first and second series of measurement locations.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 illustrates a front perspective view of an example survey mechanism including onboard sensors that may be used for performing a road survey by a vehicle, in accordance with some examples;

FIG. 2 illustrates a side schematic view of an example road survey system associated with a vehicle, in accordance with some examples;

FIGS. 3A and 3B illustrate respective side and top views of a schematic representation of an example road survey system associated with a vehicle, in accordance with some examples;

FIG. 3C is a diagram illustrating an example of data acquisition events corresponding to road surveying information indicative of a sequence of target road sections each comprising one or more road segments for a road survey, in accordance with some examples;

FIG. 4 is a diagram illustrating an example of a process that can be used for visualization of location-correlated road survey data frames obtained in road surveys performed for different acquisition times and/or acquisition years, in accordance with some examples;

FIG. 5 illustrates an example of a multi-year correlated view of road survey data frames obtained from different respective road surveys, where the multi-year correlated view includes respective pavement and environment images from each of the different road surveys, in accordance with some examples;

FIG. 6 illustrates another example of a multi-year correlated view of road survey data frames obtained from different respective road surveys, where the multi-year correlated view includes respective pavement and environment images from each of the different road surveys, in accordance with some examples;

FIG. 7 is a diagram illustrating an example of a process that can be used for determining and visualizing changes in road surface characteristics and/or features across location-correlated road survey data frames obtained in road surveys performed for different acquisition times and/or acquisition years, in accordance with some examples;

FIG. 8 illustrates an example of a multi-year correlated view of road survey data frames obtained from four different road surveys performed for four different acquisition years, in accordance with some examples;

FIG. 9 illustrates another example of a multi-year correlated view of road survey data frames obtained from four different road surveys performed for four different acquisition years, in accordance with some examples;

FIG. 10 illustrates an example of year-over-year road surface change analysis and visualization corresponding to a multi-year correlated view of road survey data frames obtained from a first road survey performed for a first acquisition year and a second road survey performed for a second acquisition year, in accordance with some examples;

FIG. 11 is a flow diagram illustrating an example of a process for road surveying, in accordance with some examples; and

FIG. 12 is a block diagram illustrating an example of a computing system for implementing certain embodiments of the present technology, according to embodiments of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Road surveying operations may be performed using specialized road surveying vehicles with dedicated or integrated road survey sensor arrays and mechanisms, and/or may be performed using non-dedicated vehicles with onboard sensors and/or externally coupled road survey sensor arrays and mechanisms. Road surveying operations can be used to support infrastructure management, for instance based on collecting detailed data about road and pavement conditions, which may be used to maintain and improve road networks in an efficient manner. For example, a road surveying vehicle (e.g., also referred to as vehicle-based road survey system or platform, a vehicle road survey system or platform, a road survey vehicle, a road profiler system or platform, and/or a road profiler vehicle, etc.) can be used to collect road survey data corresponding to or indicative of a topography and texture of pavement (e.g., the paved surface of a surveyed road, road section, road segment, etc.).

For example, road survey data can be obtained corresponding to one or more features, characteristics, areas, portions, etc., of a road surface upon which the road survey vehicle travels. The road survey data may be obtained, measured, and/or collected, etc., by the road survey vehicle as the road survey vehicle drives, travels, or otherwise traverses the various road segments and sections that are the subject of a given road survey being performed. In some aspects, a road survey vehicle can be used to collect pavement information (e.g., road survey data) using multiple sensors types and multiple modalities. For example, onboard sensors of a road survey vehicle may include lasers, cameras, radars, among various other sensors and sensor types, which can be used to collect pavement information (e.g., road survey data) at up to highway speeds of the road survey vehicle. In some cases, the road survey data can correspond to or indicate pavement condition information based on measuring pavement roughness, rutting, texture, and/or various other conditions and characteristics, as well as pavement imagery (e.g., downward facing images of the pavement below the road survey vehicle) and/or right-of-way (RoW) imagery (e.g., front, rear, lateral, etc., images of the surrounding environment in which the pavement or road surface is located, etc.).

Road survey vehicles and platforms can include various onboard sensors and instruments for obtaining the road survey data. For example, the onboard sensors of a road survey vehicle and/or otherwise associated with performing road surveying operations can include, but are not limited to, one or more of Light Detection and Ranging (LiDAR) scanners, high-resolution cameras, inertial measurement units (IMUs), inertial navigation systems (INSs), Global Navigation Satellite System (GNSS) receivers, laser profilometers, radar or ground penetrating radar (GPR), etc.

As the road survey vehicle is driven along a road, the various onboard sensors are used to perform data acquisition. The road survey data that is acquired by the road survey vehicle during the road survey operations can include road survey data indicative of road geometry information, such as horizontal and vertical alignment, cross-sectional profiles, land widths and shoulder dimensions, etc. The road survey data may additionally be indicative of road surface condition information, such as surface roughness (e.g., international roughness index (IRI)), rutting depth and/or width, cracking (e.g., type, severity, extent, etc.), texture, etc. In some examples, the road survey data may be indicative of pavement structure information, including layer thickness, subsurface anomalies or defects, etc. In some examples, the road survey data may be indicative of various roadside features, such as signs, guardrails, or other assets, vegetation encroachment, etc. For example, the road survey data can include pavement images and/or right-of-way images from respective pavement cameras and/or right-of-way cameras included in the onboard sensors of the road survey vehicle, which may capture images indicative of the various roadside features, pavement paint features, pavement surface, etc. In some cases, the road survey data can be indicative of drainage features and corresponding drainage information, such as the location and condition of culverts and various other drainage structures or mechanisms.

In some examples, the road survey vehicle can include one or more lidars and/or a mobile laser mapping system, which can be used to perform optical-based sensing to determine the position, orientation, and other characteristics of pavement and/or roadside objects. Lidar and/or laser mapping sensor data can be collected continuously as the road survey vehicle travels along the road surface, with the continuous collection performed over a configured field of view or area of view associated with the lidar or laser mapping sensor(s).

One or more inertial sensors, IMUs, INSs, accelerometers, etc., can be used to collect sensor data that can be used for positioning of the road survey vehicle. For example, inertial sensor data can be used to determine real-time positioning and/or kinematics information corresponding to the road survey vehicle, including real-time position and orientation tracking. In some cases, the inertial orientation data can be based on a combination of onboard sensors of the road survey vehicle, including IMUs, INSs, accelerometers, etc., as noted above, and/or one or more of gyroscopes (e.g., including fiber optic gyroscopes), differential GPS, distance measuring instrument (DMI), etc. The DMI can be used to measure linear distance travelled by the road survey vehicle, and may additionally provide a GPS position backup that may be used, for instance, in the event of a lost or poor quality satellite connection, etc. In some cases, positioning data for the road survey vehicle can be augmented or determined for a second sensor modality corresponding to a GPS or other GNSS satellite-based positioning system. For example, the road survey vehicle can be configured with a differential GPS system integrated with a DMI and inertial measurement system (IMS) that can be used to augment or supplement the real-time positioning information of the road survey vehicles in cases where GPS or satellite reception is lost, or falls below an accuracy or uncertainty threshold, etc.

As noted above, road survey data can include one or more types of imagery captured by onboard cameras of the road survey vehicle. In some cases, the captured imagery can comprise still-image photographs and/or video data (e.g., a sequence of video frames comprising still image frames, etc.). In some examples, a road survey vehicle can include multiple cameras that may be used to capture right-of-way images and/or video (e.g., right-of-way imagery), which can be used to provide a virtual road view at various orientations around the road survey vehicle within the roadway environment.

A ground penetrating radar (GPR) can be used to detect changes in road structure, including material thickness, composition, condition, etc. The road survey vehicle may include one or multiple GPRs, which can be oriented above the roadway surface to collect GPR scan data while the road survey vehicle travels along the road surface. One or more onboard sensors of the road survey vehicle can be used to measure information indicative of or otherwise corresponding to a texture of the pavement (e.g., road surface texture, etc.), a roughness, etc. For example, the one or more onboard sensors can measure the mean profile depth of the road surface macrotexture. In some aspects, one or multiple pavement scanners can be included in the onboard sensors of the road survey vehicle, and can be used to obtain continuous pavement scan data across a full lane width (e.g., a full width of the travel lane of the road survey vehicle). For example, the pavement scanner(s) of the road survey vehicle can be configured to calculate or measure the full lane width texture. In some examples, a subsystem of the pavement scanner system can be used to measure or determine road survey data corresponding to pavement distress information. For example, the pavement distress subsystem can be used to collect 3D road profile data, which can be used for automated distress detection and image display. In some examples, the pavement scanner system can additionally or alternatively be configured to obtain accurate measurements of the transverse profile of the road, which can be used to determine rutting information (e.g., to identify and/or characterize or quantify the presence of one or more detected ruts on the road surface, etc.). In some cases, the pavement scanner system can be configured to measure the transverse profile of the road with a resolution on the order of 4,000 measurement points over a 4-meter span (oriented across the lane width, etc.). In some cases, one or more laser scanners of the road survey vehicle can be configured and used to measure longitudinal road profile information, which can be used to obtain roughness information via a real-time roughness index calculation, etc.

Road survey data can be processed and used to create georeferenced datasets, which in some examples may be integrated into one or more Geographic Information Systems (GIS) for visualization and analysis by users. For example, road survey data can be used to perform comprehensive assessments of road network conditions, based on the objective and quantitative data captured during the road surveying operations and represented within the collected road survey data. Road survey data can be collected in an automated or semi-automated fashion, for example as a road survey vehicle is driven over a sequence of various road segments that are of interest for the particular road survey. The relatively high-speed of data collection provided by vehicle-based road surveying (e.g., relative to manual road surveying and other visual inspections, etc.) can increase the efficiency of operations, and may additionally minimize traffic disruptions

As noted above, road surveys may be employed as a periodic data collection process that drives road and pavement modeling for infrastructure and asset management programs. The collection of multiple road surveys, each with a different acquisition time/date (e.g., different years of each road survey, etc.), an aggregate set of road survey data can be collected and used for trend analysis, for example to monitor and/or determine various pavement condition trends over the multiple collection cycles of the road survey data. Multi-year or multi-survey (e.g., multi-collection cycle) analysis of road survey data can be improved by improved data consistency between consecutive collection cycles. In an illustrative example of a multiple collection cycle road surveying program, multiple road surveys may be performed for a given portion or length of road surface or pavement. For example, a length of road surface may be surveyed at a periodic interval, such as one survey every year, every two years, every five years, etc. Conducting multiple road surveys can be used to evaluate the pavement condition over time, for example including detecting degradation in the pavement condition over time, including detection of newly formed cracks, potholes, or other defects, as well as detection or characterization of expansion and further degradation of existing cracks, potholes, etc., that were previously present in the road surface. Management of pavement condition and associated roadway assets may be based on an understanding or knowledge of how the pavement and roadway assets are performing over time. The performance over time for pavement and related roadway assets may correspond to the pavement condition over time, with better performance associated with fewer observed degradations, cracks, potholes, etc., as the pavement ages, typically over multiple years. Individual road surveys can be performed to collect large volumes of data that characterize or represent various features and characteristics of the pavement surface along the length of the road survey track (e.g., the length of surveyed road surface), with various granularities and sensor modalities used to provide further dimension to the individual road survey datasets.

Based on pavement and roadway assets being installed for service lives of multiple years, or in some cases decades, modeling the previous and future performance of pavement assets is based on multi-year analyses and comparisons between multiple different individual road survey datasets, such as the respective road survey datasets obtained for multiple previous years for a road that is surveyed annually, bi-annually, etc. Accurately referencing road survey datasets and/or individual road survey data frames for particular measurement locations, and performing such references based on comparisons across multiple different years of respective road survey datasets, can be a cumbersome and time-consuming process. For example, manually referencing datasets from multiple years and/or road survey collection cycles, for the same asset and at the same location, may require finding the correct matching images across years, as well as accounting for changes in the survey conditions (e.g., such as changes in angle, lighting, and identifying changes between road survey images or data frames from different years as being due to circumstantial change in conditions or a true underlying change of the pavement condition of the road, etc.). There is thus a need for systems and techniques for improved correlation, visualization, and/or analysis of road survey data acquired for different road surveys with different acquisition times. Systems and techniques that can be used to more accurately and efficiently reference road survey datasets from multiple years and/or collection cycles for the same road asset at the same location(s) may be beneficial. For example, systems and techniques that can automatically and accurately determine location correlation information to match a road survey data frame corresponding to a first pavement location measured for a first year, to a closest (e.g., spatially closest) road survey data frame corresponding to a second pavement location measured during a second year, may be beneficial for improvement pavement management and monitoring, including for modeling previous and future performance of road assets measured across multiple road survey collection cycles.

Systems and techniques are described herein for location correlation of respective road survey data obtained across multiple time instances, such as respective road survey data obtained for multiple road surveys performed for different acquisition years and/or collection cycles, etc. In some embodiments, the systems and techniques can be used to provide automatic correlation and/or mapping of a requested pavement location to the respective road survey data frame that includes the requested pavement location in each of multiple different road survey datasets performed for different acquisition times. For example, the systems and techniques can be used to automatically determine location correlation information between multiple sets of road survey data frames, where each set of road survey data frames is obtained for a different acquisition time (e.g., survey year, etc.) and using different, respective measurement location information for each individual road survey.

In some aspects, a specified location on a roadway can be correlated from two different road surveys performed for the same portion of roadway in two different years (e.g., and/or can be correlated from multiple different road surveys performed for the same portion of roadway in multiple different years, etc.). In some cases, the correlation can be performed based on a user input indicative of a requested viewpoint along the length of surveyed road, and the highest correlation and/or closest matching road survey frame to the requested viewpoint can be determined from the respective set of road survey data frames obtained for each of the multiple years with a road survey conducted. In another example, the correlation can be performed based on configuring one of the multiple road surveys as a baseline or reference source of location information for the correlation calculations, with the remaining road surveys correlated against the baseline or reference location given by the respective measurement location information attributed to or otherwise associated with each frame of the road survey used as the baseline reference.

In some examples, the location correlation information determined between at least two sets of road survey data frames (e.g., obtained for at least two different road surveys performed at different acquisition times/years) can be used to provide a user of a road survey visualization application with a multi-year correlated view of one or more requested viewpoints along the surveyed length of the road. For example, the requested viewpoint can be a viewpoint indicated or determined by a user input to the visualization application, representing the requested or configured visualization view into the available road survey dataset(s). A first portion of the multi-year correlated view can depict the one or more selected frames of a first set of road survey data frames (e.g., obtained for a current year road survey) determined to include the requested viewpoint location, and a second portion of the multi-year correlated view can depict one or more selected frames of a second set of road survey data frames (e.g., obtained for a prior year road survey) that are also determined to include the requested viewpoint location.

In some cases, the selected frames of the first set of road survey data frames from the current year road survey can be selected based at least in part on maximizing a correlation with and/or minimizing a distance from the requested viewpoint location. In some cases, the selected frames of the second set of road survey data frames from the prior year road survey can be selected based at least in part on maximizing a correlation with and/or minimizing a distance or difference from the selected frames of the first set of road survey data frames for the current year road survey. The selected frames of the second set of road survey data frames may additionally, or alternatively, be selected based on maximizing a correlation with and/or minimizing a distance from the requested viewpoint location. In some embodiments, the multi-year correlated view of the respective frames correlated to a requested viewpoint and obtained from multiple different road survey data sets can be presented as a side-by-side view to the user.

In some embodiments, the multi-year correlated view can be updated simultaneously or synchronously across all of the respective views of a single year and/or single road survey data set included in the multiple years of road survey datasets that are being visualized and/or analyzed using the systems and techniques described herein. For example, the user may update the requested viewpoint to move forward, backward, left, right, zoom in, zoom out, pan, etc., the viewed portion of the surveyed roadway surface or surrounding environment, and the visualization can automatically update the respective selection of road survey data frames for each different road survey/acquisition year of the multiple road surveys/acquisition years included in the side-by-side visualization. The updates to the side-by-side view of the multiple years of road survey data frames can additionally be performed based on the location correlation information between the respective frames and measurement locations associated with each respective set of road survey data frames from each road survey acquisition year, as described above.

Further aspects are described below with respect to the figures.

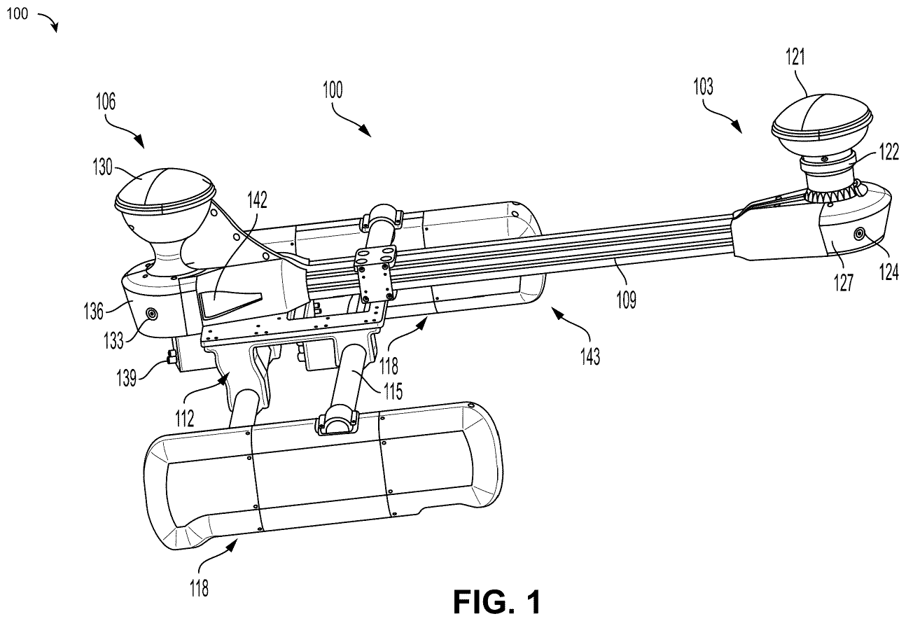

FIG. 1 illustrates a front perspective view of an example survey mechanism including onboard sensors that may be used for performing a road survey by a vehicle, in accordance with some examples. In some examples, the survey mechanism can also be referred to herein as a vehicle-based road survey system or platform, a vehicle road survey system or platform, a road survey vehicle, a road profiler system or platform, and/or a road profiler vehicle, etc. In some examples, the survey mechanism can be implemented or provided as a portable and detachable survey mechanism that can be removably attached and detached from a vehicle configured to perform one or more road surveys. In some cases, by allowing a detachable coupling, the survey mechanism can be implemented without a dependence on a particular vehicle chassis or required integration into a dedicated vehicle for performing the road surveys. In other examples, the survey mechanism may be implemented with a non-detachable, permanent, and/or semi-permanent coupling or integration to a road survey vehicle. For example, the survey mechanism may in some cases be combined or integrated with a particular vehicle chassis or dedicated vehicle for performing the road surveys.

The road survey mechanism can include a plurality of onboard sensors used by the road profiler vehicle to perform a road survey. For example, one or more three-dimensional sensor can be included, where the one or more three-dimensional sensors are positionally rigid with respect to their location(s) on the frame of the road survey mechanism, such that the location of the sensor is known within the system. One or more three-dimensional sensors can be coupled to the frame and obtain a three-dimensional topography of the road and the surrounding environment upon which the vehicle travels. A navigation system is provided to measure the position of the mechanism, and an inertial measurement unit is provided to measure an orientation of the mechanism, each at a given time. The mechanism is therefore able to accurately measure a three-dimensional topography of a road and the surrounding environment for and during the performing of the one or more road surveys configured for the road profiler vehicle (e.g., road survey vehicle).

As shown in FIG. 1, a road survey mechanism 100 can includes a front pod 103 and a rear pod 106 with a beam 109 extending between the front pod 103 and the rear pod 106. The road survey mechanism 100 can further include a frame 112 with at least one crossbar 115, and with at least one three-dimensional sensor 118 coupled to the crossbar 115. The three-dimensional sensor(s) 118 can be included in a plurality of onboard sensors of the road survey mechanism 100, and can be used to measure a three-dimensional topography of a surface upon which the vehicle is traveling (e.g., a road, one or more road sections, one or more road segments (where each road section comprises one or multiple road segments), etc.). The front pod 103 can include a front antenna 121 and a Light Detection and Ranging (LiDAR) sensor 122. The front pod 103 may include one or more front pod camera(s) 124 and a front cover 127 surrounding the front pod camera(s) 124. Similarly, the rear pod 106 can include a rear antenna 130 and rear pod camera(s) 133, with a rear cover 136 surrounding the rear pod camera(s) 133. The at least one camera 124, 133 can be coupled to the frame 112.

An inertial measurement unit (IMU) 139 can be coupled to the rear pod 106 for measuring an orientation of the road survey mechanism 100 continuously, periodically, aperiodically, intermittently, etc. Based on the road survey mechanism 100 being coupled or otherwise attached to a road survey vehicle, the inertial measurements and/or orientation information of the road survey mechanism 100 can be treated as being the same as or equal to the corresponding inertial measurements and/or orientation information of the road survey vehicle, and/or can otherwise be used to calculate or derive such information for the road survey vehicle that includes the road survey mechanism 100 and IMU 139. In some examples, the IMU 139 can be included in an inertial navigation system (INS) of the road survey vehicle and/or the road survey mechanism 100. The IMU 139 may include one or more inertial sensors, including accelerometers, gyroscopes and/or gyro sensors, magnetic sensors, orientation or heading sensors, etc.

In some cases, the rear pod 106 can be rigidly coupled to the beam 109, which itself is rigidly coupled to the front pod 103, which is rigidly coupled to the frame 112, to comprise the entire rigid system of the mechanism 100. A vent 142 can be defined within the rear cover and can communicate with the rear pod camera(s) 133 to permit air flow over the rear pod camera(s) 133. The front pod 103 can provide data more easily captured from the front portion of a vehicle through the various components of the front pod 103. The front pod 103 can include a front pod common reference point (e.g., such as a virtual point at a base of the LiDAR sensor 122). In some examples, a rear common reference point can be a vertical axis that extends through the vertical axis of the rear antenna 130. The front common reference point can be the virtual point at which the LiDAR sensor 122 treats as its origin for purposes of computing x, y, and z values of measured objects. The LiDAR sensor 122 and front antenna 121 can be aligned along a vertical axis that extends through this point to simplify the data processing steps when digitally recreating the surface and surrounding topography. Similarly, the rear common reference point can be a point on a vertical line that extends through the vertical axis of the rear antenna 130. In some embodiments, the rear common reference point is a point on the cover of the inertial measurement unit 139. A laser 148, inertial measurement unit 139, and rear antenna 130 can all be aligned along a plane that extends through this line. By establishing these two known points, the road survey mechanism 100 can determine the exact position of the front pod 103 and rear pod 106 during the measurement process and measure other values with respect to these common reference points. By maintaining two common reference points, this also allows the beam 109 to be different lengths depending on the specific project.

The front antenna 121 and/or rear antenna 130 can be an antenna associated with a navigation system (e.g., a vehicle navigation system, an onboard inertial navigation system (INS), etc.) that measures and outputs a global position of the road survey mechanism 100 and/or the road survey vehicle to which the road survey mechanism 100 is coupled. To this end, the front antenna 121 and/or the rear antenna 130 can individually or collectively act as a navigation system coupled to the frame 112 and can be configured to measure and output a position of the road survey mechanism 100 at a given time. For example, the navigation system can be a global positioning system (GPS), a global navigation satellite system (GNSS), an inertial navigation system (INS), a radio frequency identification (RFID) navigation system, a dead reckoning navigation system, a visual odometry system, a celestial navigation system, a beacon-based navigation system, a laser-based navigation system, and/or a magnetic navigation system, etc.

The LiDAR sensor 122 can be coupled to the frame 112 and configured to detect a distance from the LiDAR sensor 122 to an object. The LiDAR can use eye-safe laser beams to “see” the world in three dimensions. For example, the LiDAR sensor 122 emits laser pulses towards objects in its vicinity and measures the time it takes for the pulses to reflect back to the LiDAR sensor 122 after reaching the objects. By precisely timing the return of these pulses, the LiDAR sensor 122 calculates the distance to each object, creating a detailed three-dimensional map of the environment. The LiDAR sensor 122 is also able to output distance measurement data so that the road profiler or road survey system can correlate the distance measurement data with images captured by the front pod camera 124 or rear pod camera 133. In this manner, the distance to the images (e.g., objects represented therewithin) can be determined. Additionally, the LiDAR sensor 122 can capture the intensity of the returned laser light, providing information about the objects' reflectivity or material properties.

The front pod camera(s) 124 and the rear pod camera(s) 133 can be coupled to the frame 112 and can face a substantially horizontal direction that is substantially parallel to the surface upon which the vehicle is traveling. The front pod camera(s) 124 and rear pod camera(s) 133 can be any camera capable of capturing all or part of an image. For example, the front pod camera 124 can be a digital single-lens reflex (DSLR) camera, a mirrorless camera, a compact digital camera, a panoramic camera, a thermal imaging camera, a multispectral camera, or a hyperspectral camera. The choice of camera depends on factors such as the desired image resolution, spectral sensitivity, field of view, and environmental conditions in which the surveying mechanism operates. By employing a suitable camera, the front pod camera(s) 124 facilitates the acquisition of high-quality visual data essential for precise surveying and mapping applications. The rear pod camera(s) 133 can be the same type of camera as the front pod camera 124 or, in some embodiments, is a different camera. Further, as will be described in more detail below, the front pod camera 124 and rear pod camera 133 can be a plurality of cameras angularly separated to capture a wide range of images, in some cases 360 degrees of images.

The frame 112 can act as the structural backbone of the mechanism 100. For example, the beam 109 can be considered part of the frame 112 in some embodiments, because the front pod 103 couples to the rear pod 106 via the beam 109. The crossbars 115, beam 109, and the frame 112 can be rigid so that locational accuracy can be confirmed within the data collected by the mechanism 100. In some cases, the mechanism 100 can include a coupling mechanism 143 configured to detachably couple the frame 112 to a vehicle (e.g., a vehicle configured for performing the road survey, also referred to as a road survey vehicle or a road profiler vehicle, etc.). The coupling mechanism 143 can be, for example, a clamp system, magnetic attachment, suction device, mechanical fasteners such as bolts or screws, snap-fit connectors, locking pins, hook-and-loop fasteners, adhesive bonding, quick-release mechanisms, or any combination thereof. The coupling mechanism 143 may incorporate adjustable or telescoping features to accommodate different vehicle dimensions, as well as built-in safety locks or release triggers to enhance security and ease of detachment when required. The coupling mechanism 143 also may include shock and vibration damping components. These shock and vibration components decouple the dynamics of the vehicle from the survey mechanism 100 to achieve better data collection precision.

The inertial measurement unit 139 can be coupled to the frame and configured to measure and output an orientation of the road survey mechanism 100 at a given time. For example, the inertial measurement unit 139 can measure and report one or more (or all) of acceleration, angular rate, and magnetic field data, enabling tasks such as motion tracking, navigation, and stabilization. In examples where the road survey mechanism 100 is implemented or provided with multiple three-dimensional sensors 118, the inertial measurement unit 139 can output data permitting the angle between the plurality of three-dimensional sensors 118 to be determined. For example, the inertial measurement unit 139 can dynamically measure an angle between the plurality of three-dimensional sensors 118 during operation of the mechanism 100. The inertial measurement unit 139 can be any device capable of measuring the inertia of the vehicle and/or the mechanism 100 and an angle thereof. For example, the inertial measurement unit 139 can be an Inertial Measurement Unit (IMU) incorporating accelerometers, gyroscopes, and magnetometers to precisely determine the vehicle's linear and angular motion in three-dimensional space. Alternatively, the inertial measurement unit 139 can include MEMS (Micro-Electro-Mechanical Systems) sensors, fiber optic gyroscopes, or piezoelectric sensors, each offering unique advantages in terms of size, accuracy, and power consumption for effectively monitoring and analyzing the vehicle's dynamics and orientation.

The navigational system and inertial measurement unit 139 can be designed to determine precise spatial and orientation data in a global reference frame. Specifically, these features can collectively deliver coordinates in three dimensions (X, Y, Z), orientation data (heading, roll, pitch), and time synchronization, all referenced to the navigation system framework. The orientation components—heading, roll, and pitch—are ascertained based on local-level measurements, correlating with gravitational forces at the specific location of measurement. The system utilizes a defined geometric relationship, encompassing both the coordinates (X, Y, Z) in the frame 112 and rotational angles around these three axes. Understanding this geometric configuration, the system is capable of translating the sensor-specific data into the global context. As noted above, the three-dimensional sensor 118 can be coupled to the frame 112 in a positionally rigid manner. That is, the three-dimensional sensor 118 is coupled to the frame such that the three-dimensional sensor 118 defines a predetermined position relative to the frame 112. The three-dimensional sensor 118 faces a surface upon which the vehicle is traveling in a substantially vertical direction and is configured to measure a three-dimensional topography of the surface. In some examples, and as shown, multiple three-dimensional sensors 118 are provided for broader collection of surface data during and corresponding to the road survey performed using a road survey vehicle with the road survey mechanism 100 attached or integrated thereto. For example, the three-dimensional sensors 118 can be positioned a fixed distance apart from one another on opposite sides of the mechanism and their field of scan can overlap slightly to ensure full coverage of the surface while also allowing the overlap region to act as a calibration region. The three-dimensional sensor(s) 118 can determine the three-dimensional topography of the surface through laser line triangulation.

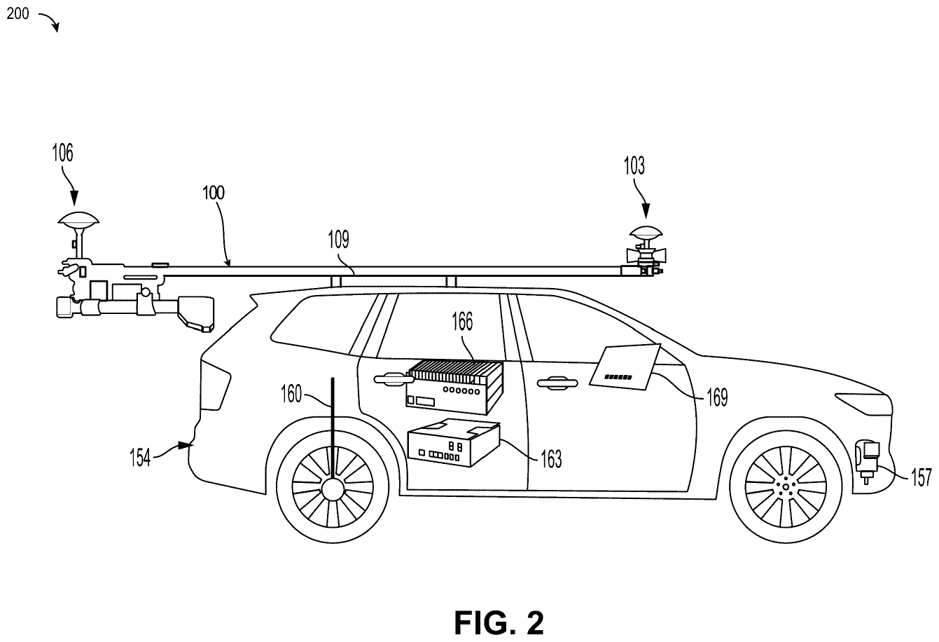

FIG. 2 illustrates a side schematic view of an example road survey system 200, which in some examples can comprise a vehicle 154 with the road survey mechanism 100 of FIG. 1 attached thereto. The vehicle 154 may also be referred to as a road survey vehicle, a road profiler vehicle, and/or a road profiler, etc. As shown, the road survey mechanism 100 is detachably coupled to a vehicle 154. The internal electrical components associated with the road survey mechanism 100 are shown in schematic form. In some examples, the vehicle 154 can be any movable object that can be controlled by a person or computer. In some embodiments, the vehicle 154 is a car, truck, trailer, scooter, go kart, airplane, helicopter, or any other transportable object. In some embodiments, the vehicle is autonomous and operates with little or no real-time interaction by a human.

In some cases, as shown, the road survey mechanism 100 can be associated with an auto-start sensor 157 for beginning the process of collecting topographical data with the functional components of the road survey mechanism 100. For example, a shaft encoder 160 may be provided for measuring a movement of at least one wheel of the vehicle 154, and a data logger 163 can receive data from the functional components of the road survey system 200 (e.g., from vehicle 154 and/or the road survey mechanism 100, and onboard sensors thereof, etc.). A control computer 166 can be provided for controlling either the vehicle 154 and/or the functional components of the road survey mechanism 100, and a user interface 169 can be provided for allowing a user to interface with the components.

In some cases, the auto-start sensor 157 can provide a signal to the control computer 166 to initiate the collection of data upon the sensing of vehicle movement. For example, the auto-start sensor 157 can be a motion sensor, such as an accelerometer or a Doppler radar sensor, installed within the housing of the vehicle 154 or attached to a chassis of the vehicle 154. Additionally, the auto-start sensor 157 may utilize global positioning data (e.g., GPS data or data from the navigation system) or wheel speed sensors to detect the onset of vehicle motion, ensuring precise synchronization between data collection and vehicle movement.

The shaft encoder 160 can be associated with at least one wheel of the vehicle 154 and can output data indicating a movement amount of the at least one wheel. The shaft encoder 160 can be any device for measuring the movement of at least one wheel of the vehicle 154. For example, the shaft encoder 160 can be an optical encoder that utilizes a rotating disk with slots or markings to generate electrical pulses as the wheel turns, providing precise measurements of distance traveled or rotational position. In some cases, the shaft encoder 160 may employ a magnetic encoder, which utilizes the changes in magnetic field patterns as the wheel rotates to determine motion. Additionally, the shaft encoder 160 could be a mechanical encoder utilizing gears or other mechanical mechanisms to track wheel movement accurately.

The data logger 163 can be communicably coupled to, and store data output by, the plurality of three-dimensional sensors 118, navigation system, front and rear pod cameras 124, 133, and inertial measurement unit 139, and/or various other onboard sensors of the vehicle 154, the road survey mechanism 100, and/or the road survey system 200. The data logger 163 can be any non-transitory computer-readable recording medium capable of recording, storing, and/or organizing data collected by the road survey mechanism 100. For example, the data logger 163 can be a solid-state data storage device such as flash memory, a hard disk drive, or a solid-state drive. Alternatively, the data logger 163 may incorporate wireless communication capabilities to transmit real-time data to a remote server or a computing device for further analysis and processing. The data logger 163 can also feature encryption mechanisms to ensure the security and integrity of the stored surveying data. The data logger 163 can therefore act as a storage associated with the plurality of three-dimensional sensors 118 and inertial measurement unit 139 and can receive data from the plurality of three-dimensional sensors 118 and inertial measurement unit 139.

The control computer 166 can be any computing device capable of directly or indirectly controlling the vehicle 154. For example, the control computer 166 can be a traditional personal computer with desktop or laptop configurations, or a modern handheld device such as a smartphone or tablet. The control computer 166 can include storage for storing data output from the road survey mechanism 100, user selections, an operating system for the control computer 166, applications and services necessary or helpful for the collection of data, or software for controlling the operation of the vehicle 154. The control computer 166 can also include a transceiver for transmitting and receiving data, as well as a processor for executing instructions, performing calculations, managing data flow, and serving as the central component responsible for carrying out computational tasks in the control computer 166. The control computer 166 can also provide the means for communicably coupling the navigation system and inertial measurement unit 139 by analyzing and synchronizing the data output therefrom. In this manner, the control computer 166 can communicably couple the at least one camera 124, 133 to the navigation system and the inertial measurement unit 139.

The user interface 169 can be any component capable of allowing user interaction with the data collected by the road survey mechanism 100 and/or the controls of the road survey mechanism 100. For example, the user interface 169 can be a touchscreen display integrated into the road survey mechanism 100, providing intuitive access to collected surveying data, control settings, and system diagnostics. Alternatively, the user interface 169 may include physical buttons, knobs, or switches along with a liquid crystal display (LCD) screen or light-emitting diode (LED) indicators for displaying relevant information and facilitating user input. Furthermore, the user interface 169 can incorporate audio feedback or voice commands to enhance usability. In some embodiments, the user interface 169 is incorporated into the vehicle 154 as a non-detachable fixture. In other embodiments, the user interface 169 is detachable, and is a tablet, personal computer, smart phone, or any other device capable of collecting user input. The user interface 169 can include navigation instructions, status reporting, error messages or other information necessary or helpful to the operation of the road survey mechanism 100.

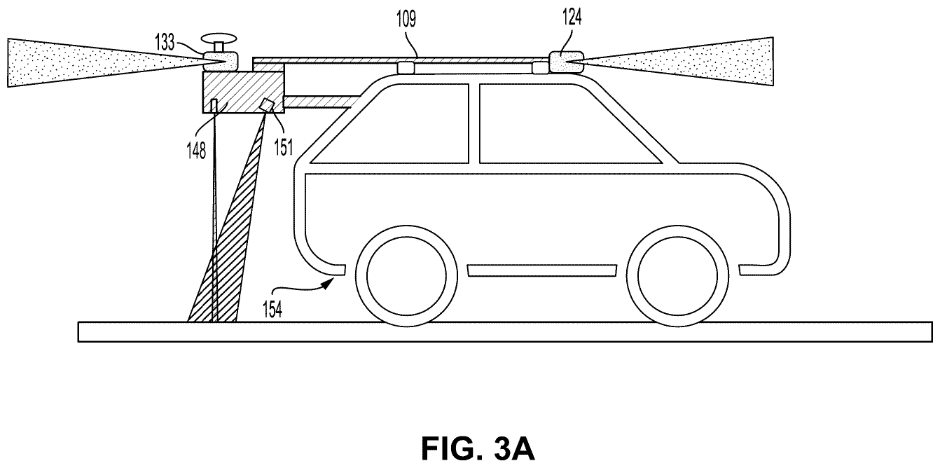

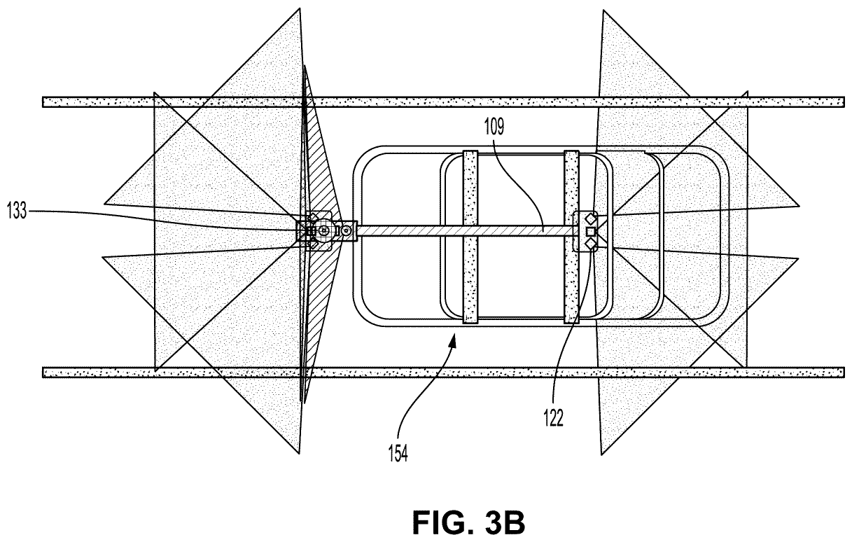

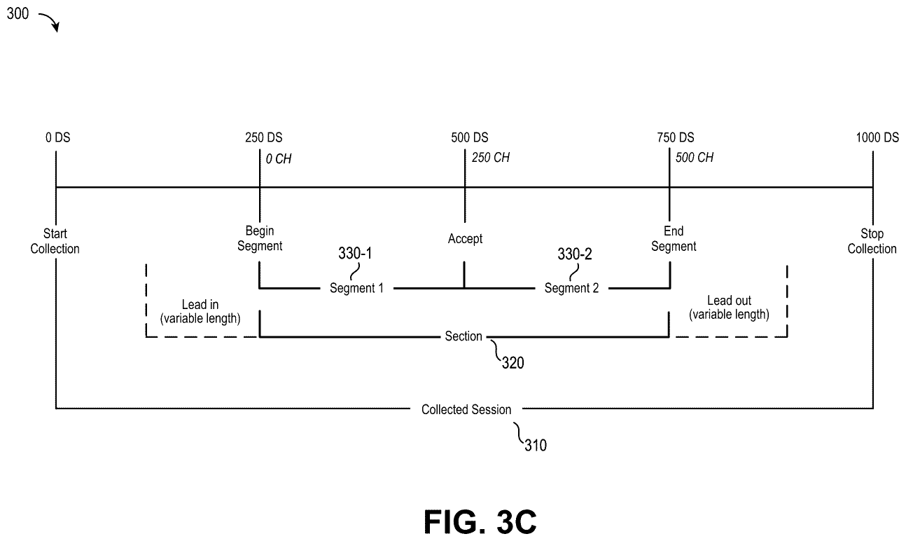

FIG. 3A and FIG. 3B illustrate respective side and top views of a schematic representation of the example road survey system including the road survey mechanism 100 associated with the vehicle 154, in accordance with some examples. For example, as shown, to perform the road survey (e.g., after starting data acquisition corresponding to a configured road survey, etc.) a laser 148 and laser sensor 151 can scan a surface upon which the vehicle 154 travels, for example a road.

For instance, the three-dimensional sensor 118 can include a laser 148 and a laser sensor 151 associated with the laser 148 and capable of receiving an angled reflection of the laser 148 so as to measure the surface upon which the vehicle is moving via laser triangulation. In some cases, laser line triangulation can be used to capture a single transverse profile of the surface (e.g., the road pavement). When combined, these sequential transverse profiles form a three-dimensional pavement surface profile. In some examples, laser triangulation is a technique used for measuring distances or shapes using a laser beam. In some cases, the laser sensor 151 is a camera, and the surface is measured by projecting a laser onto a surface and taking an image of that surface at an angle with the laser sensor 151. By analyzing the image, the distance between the laser source and the surface can be calculated, enabling precise measurements and three-dimensional scanning applications. This two-dimensional image can be taken at regular intervals, and the multiple two-dimensional images can then be “stitched” together during computer processing to form a three-dimensional image.

The laser 148 and laser sensor 151 can be any type of laser 148 and laser sensor 151 capable of carrying out laser triangulation. For example, the laser 148 can be a semiconductor laser diode emitting a narrow and coherent beam with sufficient power and wavelength stability for accurate distance measurements. The laser sensor 151 can be a photodetector or a charge-coupled device (CCD) capable of rapidly capturing the reflected laser light and converting it into precise distance measurements, providing high-resolution surface topography data. In some examples, the laser sensor 151 is a camera.

The front pod camera 124 and rear pod camera 133 can capture images at select intervals. The laser sensor 151 can similarly capture an image of the laser line emitted by the laser 148 at any interval. In an embodiment, the laser sensor 151 captures an image at a rate of approximately 28 KHz. The laser 148 and laser sensor 151 can be coupled to the frame 112 at any position, and in one example may be coupled to the frame 112 at a distance of 1.5 meters above the surface upon which the vehicle 154 travels to allow safe clearance. In some cases, the front pod camera 124 and/or the rear pod camera 133 can be configured to capture images at predefined intervals. For example, the cameras 124, 133 can capture images at predetermined time intervals. In another example, the cameras 124, 133 can capture images every 6 meters (m) based on a distance driven by the vehicle 154 while traveling over the road surface during the performance of the road survey (e.g., as determined by the navigation system and/or the shaft encoder 160 measuring movement of the wheel, etc.). Various other manners of measuring vehicle movement or time can be implemented, for example, by outputting data from the vehicle odometer, visual odometry, or any other method.

FIG. 3C is a diagram illustrating an example of data acquisition events 300 corresponding to road surveying information indicative of a sequence of target road sections each comprising one or more road segments for a road survey, in accordance with some examples. In some embodiments, the depicted data acquisition events 300 can correspond to road surveying information that is used to configure the road surveying operations performed by the road survey vehicle 154. For example, road surveying information can be obtained to specify the desired portions of a larger road network that are to be surveyed during the road survey operations of the road survey vehicle 154. In some aspects, road surveying information can comprise or otherwise be indicative of a collection of polylines, where each polyline corresponds to a target section or segment of the road network that should be surveyed. Road surveying information may comprise a subset of the plurality of polylines included in a road network definition, or a road network definition file, that corresponds to the larger road network within which the road survey is being performed. For example, the subset of polylines is indicative of the particular road surfaces that are to be surveyed, for example by using the vehicle 154 and onboard sensors and/or road survey mechanism 100 to perform data acquisition to obtain respective road survey data while the vehicle 154 travels over each one of the road surfaces indicated by a polyline included in the subset of polylines. In some aspects, the subset of polylines indicative of the road surfaces to survey can also be referred to as a roadway geometry set to be surveyed.

In one illustrative example, the example data acquisition events 300 depicted in FIG. 3C can also be referred to as road surveying information 300. In some embodiments, a road survey can be performed with one or more collected sessions 310. The collected session 310 (e.g., also referred to herein as a “session”) can correspond to the largest discrete unit of data acquisition that is obtained during the road survey. For example, a collected session (e.g., such as the collected session 310 in the example of FIG. 3C) can include all of the road survey data that is acquired from the moment that ‘Start Collection’ is triggered (e.g., shown in FIG. 3C as corresponding to ‘0 DS’) until the moment that ‘Stop Collection’ is triggered (e.g., shown in FIG. 3C as corresponding to ‘1000 DS’).

In some aspects, the various locations or event points shown in FIG. 3C along the horizontal line of the length of the collected session 310 may be expressed in units of ‘DS’ and/or in units of ‘CH’. In one illustrative example, the units ‘DS’ and ‘CH’ can be units of distance. In other examples, the units for specifying data acquisition events 300 may be units of location, position, time, etc. In some embodiments, the unit ‘DS’ shown in FIG. 3C can represent a Distance Stamp, which is calculated as a cumulative quantity or value of the total distance surveyed within the collected session 310. For example, the ‘Start Collection’ trigger that marks the beginning of the collected session 310 can correspond to a Distance Stamp of DS=0. The ‘End Collection’ trigger that marks the end of the collected session 310 can correspond to a Distance Stamp value that is equal to the surveyed length of road during the collected session 310. For example, in FIG. 3C, the ‘Stop Collection’ trigger corresponds to a Distance Stamp of DS=1,000, indicating that the collected session 310 corresponds to the road survey vehicle 154 having surveyed a total of 1,000 units (e.g., feet, meters, yards, kilometers, miles, etc.) from the ‘Start Collection’ trigger at DS=0.

In some aspects, ‘CH’ values can represent Chainage, which may be a reference indicator that is independent of the cumulative Distance Stamp values, and for example can be provided within or specified by the corresponding road surveying information or set of polylines used to configure the particular road survey operations for the collected session 310. In some cases, the Chainage values can start from an arbitrary and/or non-zero value, and additionally may increase or decrease over the course of the collected session 310. In other words, the Chainage values do not necessarily increase linearly or cumulatively, and do not necessarily track with the Distance Stamp (DS) values, which do increase linearly and cumulatively with the surveyed distance during the collected session 310.

In some embodiments, a road survey session 310 can include one or more road sections (e.g., also referred to as “target road sections” of the road survey corresponding to the road survey session 310). A target road can be a more granular unit of road surface than the larger road survey session 310. In some aspects, a road network may be divided into a plurality of different road sections. For example, a road network can be divided into a plurality of road sections in which all locators are the same. In the example of FIG. 3C, the collected session 310 includes and corresponds to a single target road section 320, although it is noted that a collection session of a road survey may include multiple target road sections. For instance, multiple target road sections can be surveyed within a collection session 310, based on road surveying information indicative of a sequence of target road sections for the road survey. A “sequence” of target road sections may refer to a plurality of target road sections that are surveyed by a road survey vehicle (e.g., vehicle 154) in some sequential order. The sequential order (e.g., the sequence) of the target road sections may be pre-determined or configured, for example by the road surveying information used to configure the vehicle-based road surveying operations. The sequential order (e.g., the sequence) of target road sections in some embodiments is not pre-determined or pre-configured, and for example can be the sequential surveying order that is chosen or driven by the operator acting as the driver of the road survey vehicle 154.

The target road section 320 comprises a subset of the continuous data acquisition of road survey data that is obtained during the collected session 310 between the ‘Start Collection’ trigger at DS=0 and the ‘Stop Collection’ trigger at DS=1000. For example, data acquisition from the road surveying mechanism 100 may be performed continuously, periodically, intermittently, etc., for the entirety of the duration of the collected session 310, with only a subset of the total data acquisition corresponding to a target road section 320 that is of interest for the road survey. For instance, the data acquisition of the session 310 that occurs after the ‘Start Collection’ trigger at DS=0 but before the beginning of the section 320 at DS=240 can be referred to as a lead in of the data acquisition for the target road section 320. The lead in of the data acquisition for the target road section 320 may have a variable length. Similarly, the data acquisition of the session 310 that occurs after the end of the target road section 320 data collection at DS=750 but before the end of the collected session 310 at DS=1000 can be referred to as a lead out of the data acquisition for the target road section 320. The lead out of the data acquisition for the target road section 320 may have a variable length, which can be the same as or different from the lead in for the same target road section 320 at the beginning portion of the collected session 310.

In some aspects, there may be one or more sessions 310 associated to one section 320. For example, a target road section 320 can be fully contained within a single session 310 (e.g., the target road section 320 is a subset of the single session 310, or is equal to the single session 310), or can span multiple different session (e.g., a first portion of the target road section 320 can be collected within a first session 310, a second portion of the target road section 320 can be collected within a second session 310, a third portion of the target road section can be collected within a third session, . . . , etc.).

A road section (e.g., target road section 320, etc.) may include one or multiple road segments. In some aspects, a road segment (e.g., the first road segment 330-1, second road segment 330-2, . . . , etc.) can comprise a single row entry within a routing file used to specify the road survey operations that are being performed. In other words, a road segment can correspond to a single polyline of the subset of polylines of the road definition file described previously above.

For example, in the example of FIG. 3C, the target road section 320 includes a first target road section ‘Segment 1’ 330-1, and a second target road section ‘Segment 2’ 330-2, although it is noted that a target road section 320 can include a greater or lesser number of road segments without departing from the scope of the disclosure. In some aspects, the road segments included within a given target road section can be continuous, such that the end point of one road segment is the same as the start point of the next road segment in the same target road section. In such examples, the total length of the target road section is equal to sum of the individual lengths of the constituent road segments within the target road section. For instance, the target road section 320 and the first road segment 330-1 can have the same start point at DS=250. The target road section 320 and the second road segment 330-2 can have the same end point at DS=750. The transition between the first road segment 330-1 and the second road segment 330-2 can be the same, corresponding to DS=500 being equal to both the end point of the first segment 330-1 and the start point of the second segment 330-2. In some aspects, the lead in and lead out associated with the target road section 320 can be configured during road survey data import, such that extra data from the data acquisition within the collected session 310 is imported with the chosen length of the respective lead in and lead out parameters, such that any discrepancy at the beginning or end of a section (e.g., target road section 320) may be overcome during segmenting.

In some examples, the collection start point and/or the collection stop point for road survey data can be determined by a user or operator of a road survey vehicle, and/or may be determined autonomously and/or semi-autonomously by the road survey vehicle or road survey system thereof. Respective start and stop points may additionally be determined for the road survey data acquisition (e.g., respective road survey data) corresponding to each road segment 330-1, 330-2, . . . , etc., of the example shown in FIG. 3C. In some cases, respective start and stop points for each road segment of a road survey can be used to associate location data or location information to each road segment. For example, the location data of a given road segment may be the average location calculated between the start and stop locations corresponding to the road segment, or may be the location of the start location of the segment, or the location of the stop location of the segment, etc.

In some examples, event points associated with the example road survey data acquisition timeline 300 for the single session 310 of FIG. 3C can be automatically determined based on inputs comprising a current position of the road survey vehicle 154 and/or a current heading of the road survey vehicle 154, along with the road geometry information as specified in the road survey configuration information or set of polylines corresponding to the configured road survey operation being performed. A current position of the road survey vehicle 154 and/or a current heading of the road survey vehicle 154 can be determined from the same onboard sensors of the road survey vehicle 154 and road survey mechanism 100 that are used to obtain the road survey data. For instance, the current position of the road survey vehicle 154 can be determined from an onboard navigation system of the vehicle 154. As described previously, in some embodiments, the front antenna 121 and/or rear antenna 130 can be an antenna associated with a navigation system (e.g., a vehicle navigation system, an onboard inertial navigation system (INS), etc.) that measures and outputs a global position of the road survey mechanism 100 and/or the road survey vehicle 154 to which the road survey mechanism 100 is coupled. In some examples, the current position of the road survey vehicle 154 can be determined based on the front antenna 121 and/or the rear antenna 130 individually or collectively acting as a navigation system coupled to the frame 112 and configured to measure and output a position of the road survey mechanism 100 at a given time. For example, the navigation system can be a global positioning system (GPS), a global navigation satellite system (GNSS), an inertial navigation system (INS), a radio frequency identification (RFID) navigation system, a dead reckoning navigation system, a visual odometry system, a celestial navigation system, a beacon-based navigation system, a laser-based navigation system, and/or a magnetic navigation system, etc.

In some aspects, a current heading of the road survey vehicle 154 may also be referred to as and/or included within a current orientation information of the road survey vehicle 154. In some embodiments, the current heading/orientation information of the road survey vehicle can be obtained from one or more IMUs, INSs, and/or inertial sensors (e.g., accelerometers, gyroscopes, gyro sensors, magnetic sensors, etc.) that are included as onboard sensors of the road survey vehicle 154 and/or the road survey mechanism 100. For example, the current heading/orientation information for the road survey vehicle 154 can be obtained from the IMU 139, etc. In some embodiments, sensor data from the same onboard sensors of the vehicle 154 that are used for the data acquisition corresponding to the road survey may also be utilized, at least in part, for automatically detecting the occurrence of various trigger events (e.g., the set of event points 300) for stopping and starting data acquisition at corresponding start and stop points of the various road segments (e.g., road segments 330-1, 330-2, . . . , of FIG. 3C, etc.), road sections (e.g., target road section 320 of FIG. 3C, etc.), and/or collection sessions (e.g., collection session 310 of FIG. 3C, etc.) that are configured for the current road survey.

In one illustrative example, the systems and techniques can obtain sensor data from the onboard sensors of the road survey vehicle 154, where the obtained sensor data is indicative of a current position of the road survey vehicle 154. For example, the current vehicle position can be determined from a GNSS, INS, or other positioning system of the road survey vehicle 154. Sensor data may additionally be obtained indicative of a current heading or orientation of the road survey vehicle 154, for example in the form of accelerometer and/or gyroscopic sensor data obtained from the onboard sensors such as the IMU 139 of the road survey vehicle 154. In some aspects, the position and heading information of the vehicle 154 may be obtained from an INS of the road survey vehicle 154.

As noted previously, systems and techniques are described herein that can be used to provide location correlation of respective road survey data obtained across multiple time instances, such as respective road survey data obtained for multiple road surveys performed for different acquisition years and/or collection cycles, etc. As used herein, a “road survey data frame” or “frame” of road survey data can refer to any measurement or sensor data, and/or various combinations or sub-combinations thereof, obtained by a road survey vehicle and/or road survey system. For example, a “frame” of road survey data can be used to refer to a subset or a portion of a larger set of collected data obtained for a road survey. Frames of road survey data can correspond to the sequential or linear collection process used by the road survey vehicle or road survey system to obtain the respective measurement data along the length of a road surface. For example, frames of road survey data may correspond to the segmented nature of the road survey collection process, and does not necessarily represent a characteristics or a geometry of the road survey data itself. For example, a “frame” of road survey data obtained from a lidar sensor may comprise a plurality of point cloud measurements representing a scanned three-dimensional space observed by the lidar measurements. A “frame” can refer to a subset of data which is collected in a continuous manner across a field of view (FOV), such that the data in a “frame” can correspond to a temporally spaced sequence of data from one side of the FOV to the other side, such as commonly may be the case in LiDAR or optical camera data. In this disclosure, a “frame” of road survey data can refer to any sensor data, measurements, derived values, calculations, etc., associated with a road surface, sub-surface, and/or environment, and corresponding to a configured length along the surveyed road surface.

For example, a frame of road survey data may be based on a configured length value comprising a distance along a direction of travel of the road surface. A 5 meter “frame” of road survey data can be obtained from any individual sensor, or combinations of sensors, associated with performing the road survey, where a particular frame of road survey data comprises the respective sensor data obtained or measured within a 5 meter “frame” along the length of the road being surveyed. In an illustrative example, road survey data collected for a total survey length can be divided or grouped into a plurality of road survey data frames with the configured frame length or frame interval used to indicate the partitioning of the collected data. A first road survey data frame can refer to various types of sensor data that are collected or measured for measurement positions between 0-5 meters; a second road survey data frame can refer to various types of sensor data that are collected or measured for measurement positions between 5-10 meters; a third road survey data frame can refer to various types of sensor data that are collected for measurement positions between 10-15 meters; . . . , etc.

The transverse dimension of the sensor data associated with a given frame can vary, based at least in part on the configuration and/or capabilities of the respective sensor used to obtain the sensor data. For example, some sensors may measure data across the width of the travel lane of the road survey vehicle. Some sensors may measure across transverse distances that are wider (e.g., greater) than the lane width. Some sensors may measure across transverse distances that are narrower (e.g., less) than the lane width. Sensors may additionally be configured to perform point measurements, or continuous measurements. A road survey data frame can include point measurements, continuous measurements, and various combinations thereof, that are measured or performed within the same “frame” of road surface area.

In some aspects, the various onboard sensors of a road survey vehicle and/or road survey system may operate with different measurement frequencies or periodicities. For example, cameras or image-based sensors can be configured to capture images triggered based on the speed or distance traveled by the road survey vehicle (e.g., capture an image every 0.5 meters, every 1 meter, etc.). The configured length of road survey data frames can be independent of the configuration(s) of the respective onboard sensors used to perform and collect respective sensor and measurement data corresponding to the road survey. For example, road survey data along a length of road surface can be collected as a plurality of discrete and/or continuous measurements obtained by each respective sensor of a group of sensors used by the road survey vehicle. The collected road survey data for the full surveyed length of road can subsequently be divided or mapped to respective road survey data frames that are used to bucket or associate the sensor data measured at the same or similar (e.g., within the configured frame length) measurement locations along the road. Individual measurements from the various onboard sensors of the road survey vehicle can be discrete measurements that are obtained independently from the choice of a configured frame length, with the set of road survey data frames created as a post-processing operation applied to the collected sensor data to group the discrete, individual sensor measurements into “frames” of survey data based measurement location. As noted above, the surveyed length of road can be divided into a continuous (or discontinuous) sequence of non-overlapping spatial sections, and the sensor data obtained or measured for or within each non-overlapping spatial section may be mapped to a corresponding road survey data frames of a set of road survey data frames determined for the overall set of collected road survey sensor data.

For example, as described with respect to the example of FIG. 3C, road surveying systems and the corresponding, collected road survey data may use linear referencing and/or linear referencing-based techniques as the primary index of captured road survey data and derived features. Indexing by linear referencing can correspond to identifying respective sensor data or other measurements by a particular recording (e.g., logging) session of the road survey during which the data was collected, with further identification then provided by the distance from the beginning of the session. For example, the distance from the beginning of the session can indicate the corresponding measurement location of a particular piece of sensor data or sensor measurement of the road, where the distance indicates the distance from the session collection start point to the measurement location of the particular piece of sensor data or measurement. In the example of FIG. 3C, linear referencing can be used to provide a primary index for collected sensor data and measurements according to the ‘DS’ index value, for instance where the sensor data between DS index 250-500 corresponds to the first segment 330-1, sensor data between DS index 500-750 corresponds to the second segment 330-2, etc. In some examples, road survey data collection may be performed with linear referencing primary indexing, rather than using a geographical coordinate system to provide the primary indexing of the respective measurement location(s) of different sensor data and measurements. Linear referencing may be used based at least in part on a greater resiliency to error and signal loss, as compared to various geographical coordinate-based indexing techniques that may rely on GPS or other satellite transmissions of reference signals for determining position or location information of a receiver. In some cases, road survey data may be indexed according to linear reference(s) to provide more precise measurement and reporting of data and features in close proximity to one another, without resolving larger scale absolute positioning errors as may commonly be associated with GPS or other satellite and/or GNSS-based positioning systems.

For example, linear references can distinguish or differentiate road survey data and sensor measurements at the granularity of the underlying distance measurement as the road survey vehicle or road survey system travels along the length of the road, away from the collection start point. The granularity or resolution of measuring the distance traveled by the road survey vehicle from the collection start point is often greater than the granularity or resolution of a GPS-based position, which may have an uncertainty or error that is an order of magnitude (or more) larger than the resolution of distance-based linear referencing or indexing techniques for road survey data collection. However, linear referencing systems may be standalone references for relative, rather than absolute, position and measurement location information. That is, each series of road survey data (e.g., road survey data frames, as discussed above) may have absolute and/or relative position information encoded by a respective linearly referenced distance value or distance index from the collection start point, allowing comparison between the various measurement locations of the same road survey collection session (e.g., allowing comparison between any measurement locations that are indexed by the same linear referencing system of distance traveled from the same collection start point). However, comparisons across different road survey data collections, which are performed at different points in times and during separate road surveying operations or instances, can be challenging to implement, based on the different road survey data collections each having a different linearly referencing system. For example, two road surveys performed in two different years for the same section of road may have differences in the collection start point, differences in the track or path of the road survey vehicle along the length of surveyed road, differences in survey speed, lane positioning or transverse location information across the width of the road (e.g., orthogonal to the direction of travel, which can be the direction of the survey line, path, track, etc.), etc.

Based on variations in the road surveys performed across different years or collection cycles, even for the same length or portion of a roadway surface, a linear referencing system used in a first road survey data set during a first year is unlikely to be the same as, or compatible with, a linear refereeing system used in a second road survey data set during a different, second year. For example, differences in the collection start point can prevent accurate comparisons or correlations across measurements of the two road surveys, as a linearly referenced distance index of 5 m (e.g., 5 meters traveled from the collection start point) will correspond to two different geographical coordinates depending on which collection start point is used to reference the distance index value. Similarly, differences in the survey path or track traveled by the road survey vehicle can further decrease the accuracy and ability to obtain compatible measurement location information from the two different linear referencing systems used for the road surveys performed at two different times. For example, the linearly referenced distance index location information, may assume straight line travel between the different distance indices, while the road survey vehicle in reality does not take a perfectly straight line path between distance indices. Variations in travel distance of the road survey vehicle can correspond to additional inaccuracies in direct comparisons between sensor data measurements from a first road survey with a first linearly referenced set of measurement locations, and sensor data measurements from a second road survey with a second linearly referenced set of measurement locations.

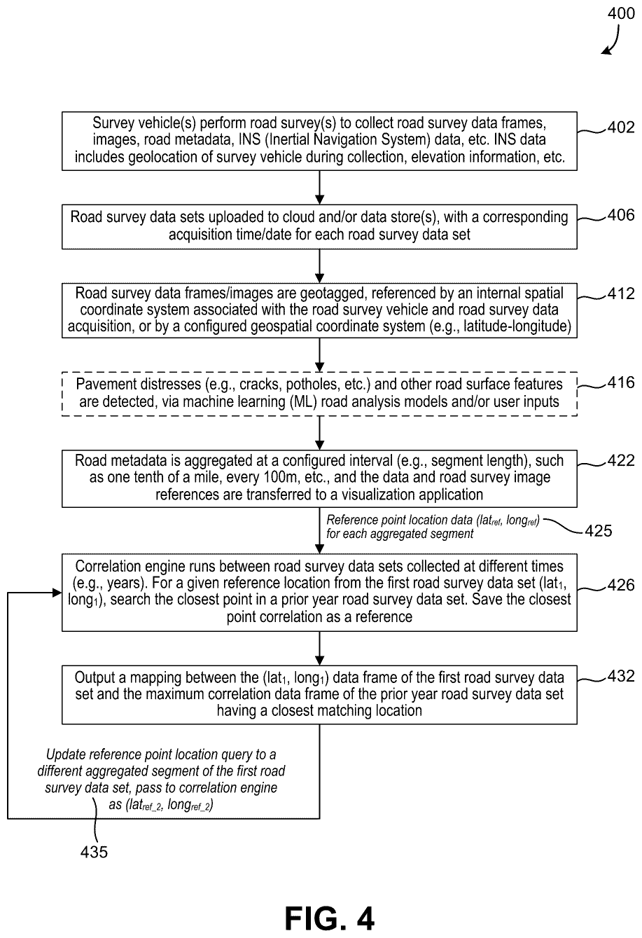

FIG. 4 is a diagram illustrating an example of a process 400 that can be used for visualization of location-correlated road survey data frames obtained in road surveys performed for different acquisition times and/or acquisition years, in accordance with some examples. For example, process 400 can be used to determine corresponding assets and locations between multiple different road surveys, including between multiple different road surveys obtained for different times, dates, and/or years of acquisition of the road survey data, and to output selected portions of road survey data frames selected from the multiple different road surveys according to location correlation information and a requested viewpoint of a user of a visualization application, as will be described in further detail below.

At block 402, one or more road survey vehicles can perform road surveys to collect a corresponding road survey dataset for each road survey. As noted previously above, a road survey dataset can comprise continuous or discrete measurements obtained from each respective sensor of a plurality of onboard sensors and sensor systems of the road survey vehicle, with one or more data processing operations performed to determine a set of road survey data frames each comprising a subset of the sensor data obtained between the collection start point and the collection stop point of the road survey. In some aspects, block 402 corresponds to performing a plurality of road surveys at different times (e.g., years, etc.), and obtaining a corresponding set of a plurality of road survey data frames for each respective road survey of the plurality of road surveys. In some aspects, the road survey data frames can comprise various types and combinations of sensor data and measurements associated with the surveyed road surface, sub-surface, surrounding road environment, etc., as discussed previously above. The road survey data collection can additionally include road survey data such as images (e.g., including pavement images, right-of-way images, etc.), road metadata (e.g., including measurement location information for the individual sensor measurements and/or road survey data frames of a particular road survey, etc.), INS or other positioning data, etc. In some aspects, the set of road survey data frames corresponding to a road survey can include the sensor data and/or sensor measurements, as well as one or more (or all) of the additional data types such as images, road metadata, INS or other positioning data, etc. In some examples, the INS or other positioning data can include information indicative of the geolocation of the road survey vehicle during the data collection process performed to obtain the road survey data frames of a road survey. The geolocation of the road survey vehicle can be linearly referenced according to a distance index or distance value from the collection start point, as noted above. The geolocation of the road survey vehicle may additionally, or alternatively, be referenced in a geographic coordinate system, for example corresponding to GPS-based or other GNSS-or satellite-based positioning systems, etc. In some embodiments, the road survey dataset for each road survey collection instance may further include elevation information, survey vehicle path or trajectory information, etc.

In one illustrative example, the plurality of road surveys performed at block 402 can correspond to at least a first road survey performed at a first time (e.g., a current year) and a second road survey performed at a second time that is earlier than (e.g., prior to) the first time. For example, the first road survey may be performed for a current year, and the second road survey may be performed for a prior year earlier than the current year, etc. In some cases, the first road survey includes a first set of road survey data frames corresponding to a first series of measurement locations along a length of road surface. For example, the first set of road survey data frames can be indexed to a first series of measurement locations along the surveyed road length according to a first linear referencing system using a first collection start point of the first road survey. The second set of road survey data frames can be indexed to a second series of measurement locations along a length of the road, which may be the same as or similar to the length of the road surveyed during the first road survey. The second set of road survey data frames can be indexed to the second series of measurement locations according to a second linear referencing system using a second collection start point, where the second collection start point of the second road survey is similar to, but different from the first collection start point used in the first linear referencing system of the first road survey and first set of road survey data frames.

At block 406, the respective road survey data sets for each respective road survey or road survey acquisition or collection instance can be uploaded to the cloud or other database or datastore, with each uploaded road survey data set including corresponding acquisition time and date information of the respective set of road survey data frames included in each road survey data set. For instance, the respective road survey data sets performed at block 402 can be used to obtain a corresponding set of road survey data frames, which can be tagged or otherwise associated with the respective time, date, year, etc., information of the road survey during upload to the cloud or other data store at block 406.

At block 412, the road survey data frames and/or road survey images (e.g., pavement images, right-of-way images, etc.) can be geotagged and referenced by an internal spatial coordinate system associated with the road survey vehicle and/or road survey data acquisition instance, or referenced by a configured geospatial coordinate system (e.g., such as a latitude-longitude geospatial coordinate system, among various others, etc.). For example, at block 412, the respective measurement location or other positioning and/or location data associated to each road survey data frame from the road survey vehicle and collection process can be converted to a common reference coordinate system, which in some aspects can be the internal spatial coordinate system, and in some aspects can be a configured geospatial coordinate system, etc. The internal spatial coordinate system may be implemented as a configured geospatial coordinate system, and vice versa. In some embodiments, the road survey data frames and images uploaded at block 406 may be stored in the converted coordinate system implemented for the geotagging and conversion processing associated with block 412. In one illustrative example, at block 412, the uploaded road survey data and images can have their respective location or measurement information converted to and stored using the World Geodetic System 1984 (WGS 84) global geodetic reference coordinate system, which is a standardized coordinate system using dimensions of latitude, longitude, and height. In some embodiments, at block 412, the uploaded road survey data and images can have their respective location or measurement information converted to and stored using the European Petroleum Survey Group (EPSG) 4326 coordinate system, where the EPSG 4326 coordinate system is a latitude-longitude (e.g., lat-long) geographic coordinate system that refers to the WGS 84 coordinate system implemented in a standardized database format.

Various other coordinate systems may also be used for the geotagging and/or conversion to the configured geospatial coordinate system at block 412, including, but not limited to, a latitude-longitude coordinate system, as noted above. A latitude and longitude coordinate system uses dimensions of latitude and longitude, and optionally, height, to specify locations on the Earth's surface. Latitude and longitude without height information may correspond to a two-dimensional location on the Earth's surface; latitude, longitude, and height can correspond to a three-dimensional location on the Earth's surface. Latitude measures how far north or south a point is from the equator, with latitude values ranging from 0 degrees at the equator to ±90 degrees at the north and south poles, respectively, with positive values of latitude corresponding to locations north of the equator, and negative values of latitude corresponding to locations south of the equator. Longitude measures how far east or west a point is from the Prime Meridian, which is set to a value of 0 degrees latitude corresponding to a location in Greenwich, England. Longitude values range from 0 to ±180 degrees, with positive values of longitude corresponding to locations east of the prime meridian, and negative values of longitude corresponding to locations west of the prime meridian. WGS 84, also known as EPSG 4326, is a geodetic system that provides a standard for mapping and navigation, and can be seen to define the shape and size of the Earth as an oblate spheroid and includes a coordinate system for specifying locations on the Earth's surface. WGS 84 is widely used in GPS and other global navigation systems.

An optional block 416 may be included in process 400, where block 416 corresponds to detecting various pavement distresses or other road surface features or characteristics corresponding to pavement damage, degradation, defect, etc. For example, the pavement distresses detected at optional block 416 may include, but are not limited to, any road surface or pavement feature or characteristic that is tracked in a road asset or pavement condition monitoring program associated with the one or more road surveys, etc. In some aspects, the pavement distresses may include cracks, potholes, ruts, or various other distresses in the paved road surface and/or sub-surface. In one illustrative example, the detection of the one or more pavement distresses at block 416 can be performed using one or more machine learning (ML) and/or artificial intelligence (AI) models, networks, or systems. For example, the one or more ML/AI models, networks, or systems can be trained to perform feature detection, classification, segmentation, etc., corresponding to detection and identification of one or more types of pavement distresses from the collected road survey data of block 402. In some embodiments, the pavement distresses detected at block 416 by the one or more ML/AI models can include road crack detection performed using one or more ML or AI neural networks trained to perform intersection-over-union (IoU) and/or mean intersection-over-union (mIoU)-based detection of road crack polylines within frames of road survey data and/or pavement images included in the road survey collected and organized as the respective sets of road survey data frames, etc.

Block 422 may be performed following the geotagging and conversion to the configured geospatial coordinate system at block 412, in examples where the pavement distress detection with one or more ML/AI networks is not performed and the optional block 416 is not implemented for the process 400. In other examples, block 422 may be performed following the pavement distress detection with one or more ML/AI networks at block 416, in examples where the optional block 416 is implemented for the process 400. At block 422, road metadata can be aggregated at a configured interval to obtain road survey data frames for later location correlation analysis across the multiple years and road collection survey data sets. For example, the road metadata can be aggregated at a configured interval comprising a length value along the surveyed length of road. In some embodiments, the road metadata may be aggregated at a configured interval corresponding to (e.g., the same as, based on, etc.) a segment length of the road survey collection process. For example, the road metadata can be aggregated into a series or set of road survey data frames for each road survey collection dataset, based on a configured interval or length such as one aggregated road survey data frame per 1/10^{th} of a mile, one aggregated road survey data frame per 100 meters, etc. Various other values of the configured interval or aggregation length for the set of road survey data frames determined for or from each road survey dataset may also be utilized without departing from the scope of the present disclosure. For example, the number of road survey data frames created from the aggregation of block 422 can be equal to the total surveyed road length for a given road survey from block 402, divided by the configured aggregation length or interval used at block 422. For an example road survey with a total length of 10 miles and an aggregation length or interval of 1/10^{th} of a mile, the 10 miles of collected road survey data can be separated and/or aggregated into respective subsets of data at 1/10^{th} mile intervals, for a total of 100 road survey data frames of 1/10^{th} mile each in the set of road survey data frames aggregated and determined from the total 10 mile collection (e.g., 10 miles/( 1/10^{th} mile)=100).

After aggregating the road metadata at the configured interval associated with or configured for block 422, the aggregated data (e.g., set of road survey data frames for each respective road survey dataset of block 402, etc.) and image references for each road survey can be copied and/or otherwise transferred to a visualization application configured to present correlated side-by-side views of a user-specified or user-requested viewpoint along the length of the surveyed road, where the correlated side-by-side views include respective frames of road survey data selected from each set of road survey data frames aggregated for each of the different road surveys performed at the different times/years. The correlated side-by-side views can include the particular road survey data frame(s) from each respective road survey that most closely correlates with (e.g., minimizes the distance to or difference from, etc.) the indicated viewpoint on the surveyed road length that is specified or requested by the user input to the visualization application.

In some embodiments, aggregating the road metadata and/or road survey data frames for each road survey dataset from a different collection time/year can include determining, for each aggregated road survey data frame, a corresponding reference point location data for each aggregated data frame. For example, an aggregated road survey data frame can include the subset of collected sensor data, of various types, that was obtained for a corresponding discrete or continuous measurement location that is within the boundaries determined for the particular aggregated road survey data frame. For example, each aggregated road survey data frame can have a frame start location and a frame end location, each given as lengths along the total surveyed length of road. The difference between the frame end location and the frame start location is the configured frame length or interval used to create the aggregated frames at block 422.

Each aggregated frame of road survey data can be associated with a corresponding reference point location data that is determined or calculated for the aggregated frame. For example, the corresponding reference point location data for an aggregated frame may be determined from one or more of the frame start location, the frame end location, the respective measurement location(s) corresponding to the subset of sensor data and measurements that are aggregated into the particular road survey data frame, etc. In some embodiments, the corresponding location for each aggregated frame can comprise latitude-longitude data, such as a respective (latitude, longitude) coordinate associated with the reference point location determined for each respective road survey data frame of the set of road survey data frames aggregated based on the configured interval/length for each different road survey dataset processed at block 422. For example, block 422 can include determining a corresponding reference point location data comprising a reference point coordinate specified as a latitude-longitude pair (lat_{reference}, long_{reference}) 425 of FIG. 4, etc.

In some embodiments, the reference location or latitude-longitude pair determined for each aggregated road survey data frame can be calculated based on averaging the respective measurement locations associated with the various sensor data and/or sensor measurements obtained during the road survey and included in the particular road survey data frame. In another example, the reference location or latitude-longitude pair determined for each aggregated road survey data frame can be calculated based on a measurement location of a last or most recent image or sensor data reading included in the particular road survey data frame. In some aspects, the reference location or latitude-longitude pair determined for each aggregated road survey data frame can be calculated based on ap[plying a different weighting to different types of sensor data or measurements, where the latitude-longitude pair assigned as the reference point location for a whole frame of aggregated road survey data corresponds to an average, minimum, maximum, median, etc., measurement location of more highly weighted types of sensor data or measurements (e.g., such as pavement scans, etc.) included in the subset of sensor data and measurements mapped to the particular road survey data frame during the aggregation performed at block 422. In another example, the reference location or latitude-longitude pair determined for each aggregated road survey data frame can be calculated to minimize the distance between an average or latest measurement location of the respective sensor data of the given road survey data frame. In another example, the reference location or latitude-longitude pair determined for each aggregated road survey data frame can be calculated based on performing minimization between the location data of separate frame locations.

In some aspects, a majority of the collected road survey data for a given road survey collection instance can comprise sensor data (of various types) associated with measurements of features or characteristics of the road or pavement surface (e.g., as compared to right-of-way images, which do not necessarily relate directly to the road or pavement surface but depict the surrounding environment within which a particular portion of road or pavement surface is located, etc.). Similarly, geo-spatial and/or GPS-based sensor data and information may also not be directly related to or indicative of features or characteristics of the road or pavement surface. Of the sensor data and measurements included in the road survey data collection that do correspond to the road or pavement surface, and features or characteristics thereof, the frame start location and the frame end location can be determined as the respective midpoints of the frame start boundary and the frame end boundary, both of which may be oriented in the transverse direction, across the width of the road and orthogonal to the direction of travel (e.g., orthogonal to the length of the road).

The start and end location of a particular road survey data frame can be specified as respective coordinates (e.g., based on converting the linearly referenced distance indices to latitude-longitude or other geospatial coordinates at block 412), or can be specified as linearly referenced distance indices, and the respective subset of sensor data and measurements mapped to each frame of road survey data aggregated at block 422 can be identified as being associated with a measurement location that is between the start and end point locations of the frame. In some embodiments, the identification of the constituent subset of sensor data and measurements for each frame of road survey data can be performed prior to the conversion or geotagging in the geospatial coordinate system, such that the subset of sensor data and measurements for each of the road survey data frames is determined while using and/or operating within the linearly referenced distance indexed location system.

In some cases, the respective measurement location for each discrete sensor data point or sensor measurement within a road survey data frame can be determined using exact GPS location data that is obtained at a periodic interval, such as every 0.5 m, etc. In other words, GPS location or other precise location information can be obtained as a respective set of sparse location information, where the sparsity is relative to the sensor data collection along the length of the road survey (e.g., sensor data is collected at a smaller/finer resolution than that associated with the GPS or other precise location information). In some aspects, the sparse GPS or other precise location information can be interpolated to obtain a corresponding location for each sensor data point within a given road survey data frame. For example, sparse GPS location data collected every 0.5 m can be interpolated to obtain an accurate, interpolated location data for the sensor data points or measurements that are obtain for measurement locations that fall between consecutive ones of the sparse GPS location data series, etc.

Different types of sensors used to perform road survey data collection can perform data collection and/or measurement at different frequencies and/or measurement intervals. For example, environmental and/or right-of-way camera images may be captured at discrete points, each of which may or may not align with a GPS or other determined location of the road survey vehicle. Discrete sensor data can be mapped to the GPS or other determined location if alignment exists, and may be mapped to a calculated interpolated location when alignment is not present.

Other types of sensor data may be approximately as a continuous collection. For example, pavement scanners may run continuously, with a measurement interval of approximately 1 mm (e.g., each discrete “scan” of the pavement scanner sensors or pavement scanner system can comprise a slice of pavement surface spanning the lane width (or other transverse imaging distance/range of the pavement scanners) and having a height of approximately 1 mm along the length of the surveyed road surface (direction of travel)). Pavement images can be derived as a combination or stitching of a plurality of 1 mm slices of discrete pavement surface scans, for instance with a 5 m “frame” of a pavement surface scan comprising a stacked or stitched series of 5 m/1 mm=5,000 discrete 1 mm slices of individual pavement scans. For the derived pavement images for the various road survey data frames aggregated at the configured interval (e.g., 5 m, 10 m, etc.), the corresponding location data or measurement location(s) for the derived pavement image can be obtained based on a combination of the sparse, discrete measurement point locations obtained for the road survey vehicle during the course of the road survey data collection, as well as the interpolated measurement locations between the discrete measurement point locations, the same as or similar to described above. In some aspects, pavement scanner data can be obtained by continuously running one or more pavement scanner lasers onboard the road survey vehicle during the data collection, to capture a plurality of 1 mm slices of pavement surface scan data. At a configured interval, the slices of pavement surface scan data are combined to derive a single pavement surface scan image at a longer length than the 1 mm slice height (e.g., combined to derive a single pavement surface scan image at the frame aggregation length, or other configured interval such as 5 m, etc.).

At block 426, a correlation engine and/or correlation algorithm can run between the road survey data sets (e.g., respective sets of road survey data frames) collected at the different survey acquisition times, dates, years, etc., to determine location correlation information between the different road survey data sets and corresponding road survey data frames. The correlation engine can determine the location correlation information such that, for a given reference location of a frame from a first road survey data set (e.g., lat₁, long₁), the correlation engine searches the closest point in a prior year road survey data set. The identified closest point correlation for the particular frame of the first road survey data set with the (lat₁, long₁) location can be mapped to the particular frame as the correlated prior year frame. The process of correlation can be repeated between each frame of the first road survey data set with a corresponding reference location information (lat_{ref}, long_{ref}) 425, to find the spatially closest, maximum correlation, minimum difference frame(s) from each respective road survey data set of the remaining road surveys obtained at block 402 for one or more prior years different from the first year.

At block 432, a mapping between the (lat₁, long₁) or other (lat_{ref}, long_{ref}) 425 used as the baseline for the location correlation information determined by the correlation engine and/or correlation algorithm can be output. For example, a mapping can be output at block 432 between the (lat₁, long₁) data frame of the first road survey data set, and the identified maximum correlation data frame of each prior year road survey data set of the one or more prior year road survey data sets included in the plurality of road surveys obtained at block 402. In some aspects, the mapping is between the (lat₁, long₁) data frame of the first road survey data set and the respective maximum correlation data frame of each prior year road survey data set, where the maximum correlation data frame is the particular data frame from a prior year road survey dataset having a closest matching location or minimum difference from the (lat₁, long₁) data frame, based on the location correlation information determined by the correlation engine at block 426. At 435, the reference point location query provided to the correlation engine as input at block 426 can be updated to the reference point location of a different aggregated segment (e.g., frame) of the first road survey data set, and can be passed as an updated input (lat_{ref_2}, long_{ref_2}) to the correlation engine, and the process 400 can return to block 426 and iterate through 426, 432, 435 for all entries or frames of the first road survey data set, until all pairwise correlations across the multiple years of road survey data have been determined and the respective references saved to a database and/or output to the visualization application.

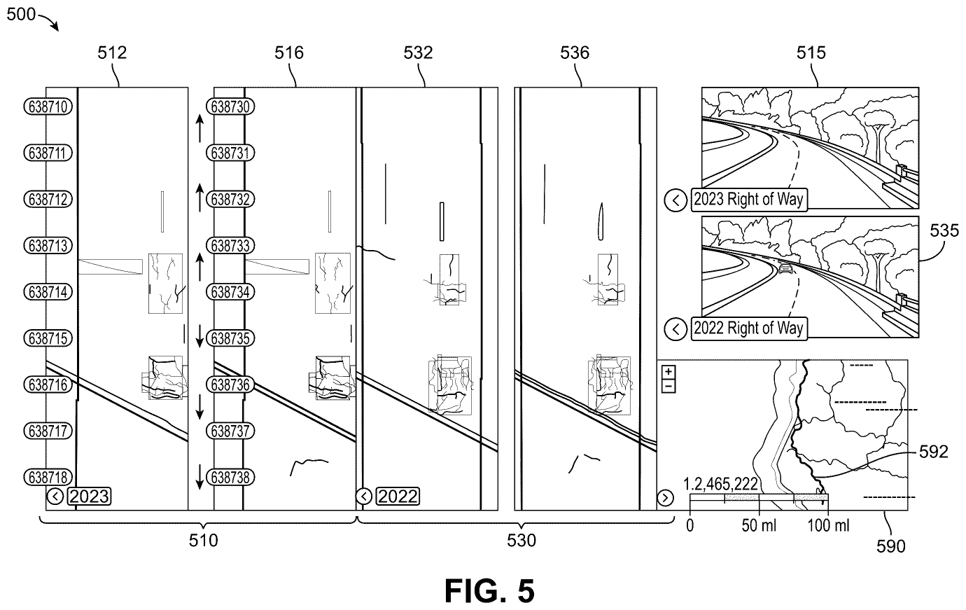

In some aspects, the multiple road surveys associated with and analyzed according to the process 400 of FIG. 4 can be performed based on road representations comprising line geometry representations. For example, surveyed roads or surveyed portions of a larger road network can be represented as a line geometry using collected geospatial data from the road survey data. The road line geometry representations can be stored in a geospatial database, and used by the correlation engine at block 426. For example, for a particular year of collected road survey data (e.g., for a current year's collected road survey data), a user can specify, pick, or indicate a point in space with (lat₁, long₁) being the geospatial coordinate representation of the user specified point in the geospatial coordinate system. Based on the specified point from the user, the correlation engine can run to find the exact or closest matching point to the user specified (lat₁, long₁) coordinate in a previously collected road survey dataset (e.g., from a prior collection year or collection cycle). When a match is found by the correlation engine, a reference to the previous road survey data collection and previous acquisition year can be stored in a database or other datastore, for example using an internal spatial reference system or other configured coordinate system. In some aspects, all collected images and road metadata for the multiple road surveys of block 402 can be retrieved using the internal spatial reference system, and/or using a configured geospatial coordinate system (e.g., WGS 84, or other latitude-longitude coordinate system, etc.). Based on the geotagged geospatial coordinate system location information associated to the stored images and road metadata for each of the multiple road survey datasets, storing the matched references determined to a previous year survey frame by the correlation engine can be the input for later retrieving the corresponding road survey data frames indicated by the correlated reference that is stored in the database for the specified location and/or matching road survey data frame(s) from the first road survey collection year. In some aspects, real-time performance may be improved based on configuring the matching algorithm of the correlation engine at block 426 to run every 5 to 10 meters of surveyed road length (e.g., the frame length, which may be the same as the configured interval or aggregation length of block 422, etc.) to determine respective references across the multi-year road survey data sets, with each of the determined correlation-based references stored in a database accessible to users of the multi-year correlated visualization application, examples of which are depicted in FIGS. 5-10, described below.

Using the correlation references determined according to process 400, accurate correlations are available between road survey data frames and measurement locations obtained for a current year road survey collection cycle data, and for each of one or more prior year road survey collection cycle data sets obtained for the same or an overlapping length of road surface. The correlation references can provide a mapping between the same physical location as measured or surveyed in each of the different years or cycles of road survey data collection, which can facilitate downstream data and image analysis, comparison, visualization, etc., across multiple time frames or time instances, which may be used for improved accuracy and efficiency in identification and/or characterization in trends of the road survey and pavement condition data. By calculating the references to previous road survey collection years or cycles as an offline or predetermined calculation, and caching the correlation-based references in a database, side-by-side correlated visualization of multiple years of road survey data can be delivered and rendered to users of a visualization application more efficiently and with minimal latency after a user picks or provides a user input indicative of the requested or desired viewpoint on the collected road for which side-by-side correlated multi-year visualization of selected frames from the different road survey collection years should be output for display. In some aspects, the user's requested viewpoint on or along the surveyed road can be converted to a measurement location in the same geospatial coordinate system (e.g., latitude-longitude) used for the road survey data frames. The converted latitude-longitude coordinate of the user's requested viewpoint can then be used as a baseline or reference for the correlation engine processing to determine the location correlation information to identify the selected subset(s) of road survey data frames to display from each of the multiple road survey datasets collected at the different times/years.

In some embodiments, the correlation engine can determine the location correlation information at block 426 based on receiving the user input indicative of the requested viewpoint, where the user input is received prior to determining the correlation information. In such examples, the correlation information can be determined for each road survey dataset to identify selected road survey data frames with a maximum correlation and minimum distance difference to the user's requested viewpoint after conversion to latitude longitude or other geospatial coordinate system used for the road survey data frames. In such cases, the correlation engine may run in real-Otime, and can output the correlation references mapping between respective selected frames of each road survey dataset directly to the side-by-side multi-year correlated visualization application. Such embodiments may also be referred to as “on-demand” or real-time correlation calculation and visualization. In other examples, the user input indicative of the requested viewpoint can be received after running the correlation information to determine respective location correlation information and the frame-to-frame mappings referencing a frame of a first road survey from a first year, to the maximum correlation frame(s) in each of one or more prior year road survey data frame sets. In such examples of pre-compiled, pre-cached, and/or pre-determined correlation mapping references, the user input indicative of the requested viewpoint can be compared against the stored references, and used to fetch and output for display (e.g., visualization) the respective frame of the first survey year with the closest matching distance to the user viewpoint, and with the side-by-side view for the one or more prior year road survey data collections obtained by retrieving the prior year survey frames indicated by the stored, cached, pre-compiled, etc., mapping reference calculated for the respective frame of the first survey year by the correlation engine as described above.

For example, FIG. 5 illustrates an example of a multi-year correlated view 500 of road survey data frames obtained from different respective road surveys, where the multi-year correlated view includes respective pavement and environment images from each of the different road surveys, in accordance with some examples. In some aspects, the multi-year correlated view 500 can be determined according to the process 400 of FIG. 4. For example, the multi-year correlated view 500 can be based on the location correlation information determined at block 426 of FIG. 4, and/or the mapping output at block 432 of FIG. 4, etc.

In some embodiments, the multi-year correlated view 500 can include, and/or can correspond to, first road survey data 510 obtained for a first road survey performed at a first acquisition time (e.g., within a first acquisition year, month, week, day, etc.). The multi-year correlated view 500 can further include second road survey data 530 obtained for a second road survey, performed at a second acquisition time that is different from the first acquisition time associated with the first road survey data 510. For example, the first road survey data 510 can be performed for a current year and the second road survey data 530 can be performed for a prior year (e.g., earlier in time/before the current year for the acquisition time and/or date corresponding to the first road survey data 510, etc.).

The first road survey data 510 and the second road survey data 530 can be obtained for the same length of roadway surface, such as a segment or section defined as a portion of a roadway network or other road infrastructure that is surveyed over multiple temporally separated instances. In one illustrative example, the multi-year correlated view 500 includes a road collection map 590, illustrating the geographic region and context within which the road surveying operations (e.g., including the collection of survey data for the first road survey data 510 in the first year/time, and the second road survey data 530 in the second year/time) were performed. In some examples, the road collection map 590 can illustrate one or more collected lengths or segments of road surface that have been surveyed, with a visual indication showing a selected or particular road collection line 592 from which the currently visualized first road survey data 510 and second road survey data 530 were obtained. For example, the road collection line 592 can correspond to the length of road surface that was surveyed in both the first and second road surveys, with the various pavement condition data frames 512, 516, 532, and 536, as well as the corresponding environment and/or right of way images 515 and 535, each collected by a road survey vehicle while traveling along the road collection line 592 (e.g., collected by a road survey vehicle configured to perform a plurality of measurements at a plurality of respective measurement locations along the road collection line 592, for each of the first road survey at the first time/year, and the second road survey at the second time/year, etc.).

The first road survey data 510 includes a first subset of road survey data frames 512, and a second subset of road survey data frames 516. In some aspects, the second road survey data 530 includes a first subset of road survey data frames 532, and a second subset of road survey data frames 536. In some aspects, the subset of road survey data frames 512 included in the first road survey data 510 can correspond to the subset of road survey data frames 532 included in the second road survey data 530. Similarly, the subset of road survey data frames 516 included in the first road survey data 510 can correspond to the subset of road survey data frames 536 included in the second road survey data 530. In an illustrative example, the respective road survey datasets (e.g., first road survey data 510, second road survey data 530, etc.) may include multiple sets or subsets of road survey data frames corresponding to the same portion(s) of road surface. For example, the first road survey data 510 includes the first subset of road survey data frames 512 and the second subset of road survey data frames 516; the second road survey data 530 includes the first subset of road survey data frames 532 and the second subset of road survey data frames 536; etc. In some aspects, the different subsets of road survey data frames included in the road survey data for a given road survey acquisition may correspond to different representations and/or different types of sensor data and/or measurements obtained corresponding to the same portion of road surface that is depicted across the different subsets. For instance, the first and second subsets of road survey data frames 512, 516 and 532, 536 can comprise an intensity map indicative of the strength of signal return from a pavement scanner measuring the road surface for the given frames, and a height map measured or determined for the same given frames.

In the example of FIG. 5, the first road survey data 510 can include intensity map information in the first subset 512 of road survey data frames, and can include elevation or height map information in the second subset 516 of road survey data frames. Similarly, the second road survey data 530 can include intensity map information in the first subset 532 of road survey data frames, and can include elevation or height map information in the second subset 536 of road survey data frames, etc. As noted above, the intensity map information (e.g., corresponding to the respective first subset 512 and 532 for the first and second road survey data 510 and 530) can represent intensity or strength of signal return from the pavement scanner, where the intensity value at each pixel location of the frame or pavement scan image indicates the magnitude or value of the pavement scanner measurement at the portion of road surface mapped to each pixel location. The height map information (e.g., corresponding to the respective second subset 516 and 536 for the first and second road survey data 510 and 530) can be indicative of relative elevation changes measured for the road surface by the pavement scanner, for the same surveyed section of road as is represented in the corresponding first subset 512, 532 of each road survey dataset 510, 530. In some embodiments, the various examples of the multi-year correlated views described herein (e.g., such as the example multi-year correlated view 500 of FIG. 5, etc.) may include a single set of road survey data frames for each road survey dataset (e.g., road survey data frames corresponding to intensity map information only, road survey data frames corresponding to height map information only, etc.). In some examples, additional subsets and frame types can be included in addition to the example of FIG. 5 in which each road survey data set includes the subset of intensity map information and the subset of height map information. For example, a third subset of road survey data frames can be included and displayed for each road survey dataset, such as a third subset of road survey data frames representing an absolute elevation map information (e.g., different from the relative elevation or height map information described above).

The multi-year correlated view 500 can further include one or more corresponding environment images obtained during or otherwise associated with the respective road surveys. For example, the first road survey data 510 obtained for the first acquisition year can be associated with a corresponding environment image 515 obtained during the same road surveying session(s) as the first road survey data 510. In some examples, the environment image 515 can be captured by one or more cameras of the road survey vehicle, including a forward, rear, and/or side-facing image capture device included in the road survey vehicle. In some examples, the environment image 515 can be a right of way image captured concurrently with the road pavement survey data represented within the first road survey data 510.

Similarly, the multi-year correlated view 500 can include one or more corresponding environment images obtained for the second road survey data 530 and/or the second acquisition time/year performed for the same length or segment of the road surface. In one illustrative example, the second road survey data 530 obtained for the second acquisition year is associated with the corresponding environment image 535 obtained during the same road surveying session(s) as the second road survey data 530. The second environment image 535 may be a right of way image captured concurrently with the road pavement surface data represented within the second road survey data 530.

In one illustrative example, the first road survey data 510 can comprise a selected portion of a first road survey dataset collected along a surveyed length of the depicted road surface, with the selected portion comprising one or more frames of the first road survey data selected according to location correlation information that can be determined by the correlation engine at block 426 and/or block 432 of FIG. 4, etc., to maximize a correlation with and/or minimize a distance or difference from the user requested viewpoint for the multi-year correlated view 500 being visualized in the example 500 of FIG. 5. The second road survey data 530 can comprise a selected portion of a second road survey dataset collected along a surveyed length of the same road surface, with the selected portion of the second road survey dataset comprising one or more frames of the second road survey data selected according to location correlation information to maximize a correlation with and/or minimize a distance or difference from the selected portion of the first road survey dataset 510. The selected portion of the second road survey dataset can be determined by the correlation engine at block 426 and/or block 432 of FIG. 4, based on calculating correlation(s) between the second road survey data 530 and the first road survey data 510, etc.

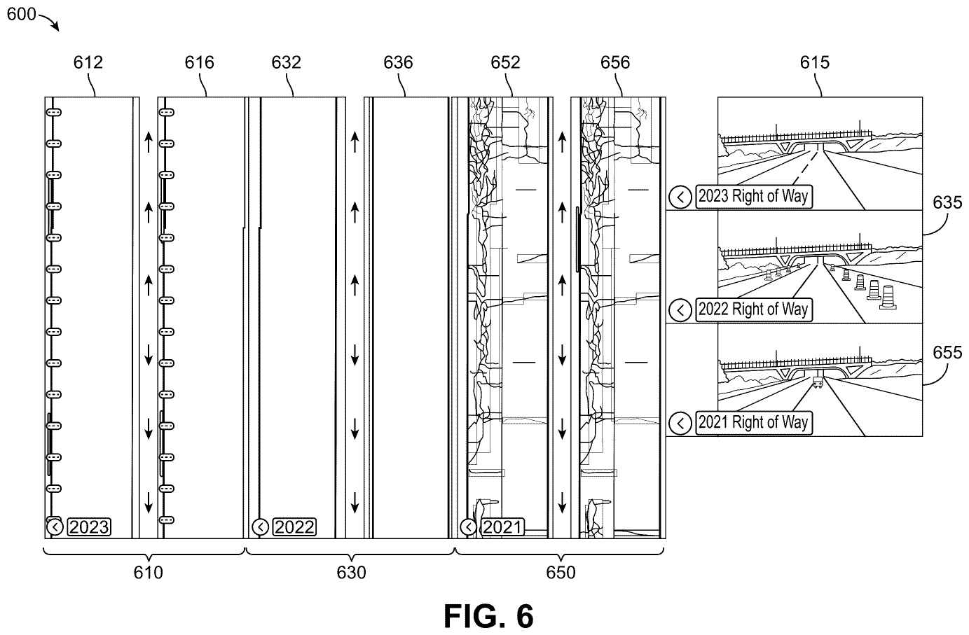

FIG. 6 illustrates another example of a multi-year correlated view 600 of road survey data frames obtained from different respective road surveys, where the multi-year correlated view includes respective pavement and environment images from each of the different road surveys, in accordance with some examples. In some aspects, multi-year correlated view 500 of FIG. 5 presents a side-by-side multi-year visualization of selected, correlated portions of road survey frames obtained for a first and second road survey performed for first and second survey years. The multi-year correlated view 600 of FIG. 6 presents a side-by-side multi-year visualization of selected, correlated portions of road survey frames obtained for a first road survey performed for a first survey year, a second road survey performed for a second survey year, and a third road survey performed for a third survey year.

In some aspects, the first road survey data 610 includes a first subset of road survey data frames 612 and a second subset of road survey data frames 616. The first road survey data 610 can be associated with (e.g., can be obtained during or within, etc.) a first acquisition year or time. A first environment image 615 (e.g., a right of way image captured by the road survey vehicle concurrently with or at the same measurement location as the data frames of the first road survey data 610, etc.) can additionally be included in the multi-year view 600. In some examples, the first road survey data 610 can correspond to, and/or may be the same as or similar to, the first road survey data 510 of FIG. 5.

The second road survey data 630 includes a respective first subset of road survey data frames 632 and a respective second subset of road survey data frames 636. The second road survey data 630 can be associated with (e.g., can be obtained during or within, etc.) a second acquisition year or time. A second environment image 635 (e.g., a right of way image captured by the road survey vehicle concurrently with or at the same measurement location as the data frames of the second road survey data 630, etc.) can additionally be included in the multi-year view 600. In some examples, the second road survey data 630 can correspond to, and/or may be the same as or similar to, the second road survey data 530 of FIG. 5.

The multi-year view 600 of FIG. 6 can further include information corresponding to a third road survey data 650. For example, the third road survey data 650 can include a respective first subset of road survey data frames 652 obtained at a third acquisition time/year corresponding to a third road survey instance, and a respective second subset of road survey data frames 656 obtained at the third acquisition time/year corresponding to the third road survey instance. The first subset 652 and the second subset 656 can be obtained simultaneously (e.g., concurrently) using two different sensor systems or sub-systems, which for example may be located at different positions on or within the road surveying vehicle, etc. The third road survey data 650 can be associated with (e.g., can be obtained during or within, etc.) a third acquisition year or time. A third environment image 655 (e.g., a right of way image captured by the road survey vehicle concurrently with or at the same measurement location as the data frames of the third road survey data 650, etc.) can additionally be included in the multi-year view 600.

The different road survey data sets (e.g., first road survey data 610, second road survey data 630, third road survey data 650) may be obtained for road surveys performed in different respective years for the same pavement or road surface, and can depict degradation and/or other changes in the pavement (e.g., road surface) features or characteristics over time. For example, pavement degradation conditions are approximately the same or similar between the survey years corresponding to the first road survey data 610 and the second road survey data 630, while pavement degradation conditions are different for the survey year corresponding to the third road survey data 650. In some aspects, the sudden or sharp increase/change in pavement degradation conditions between the road survey data 610 and 630, versus the road survey data 650 can be more efficiently and effectively analyzed based on the side-by-side correlated view presented in the example of FIG. 6.

In some aspects, the first subset of road survey data frames included in each road survey dataset (e.g., first subset 612, first subset 632, first subset 652, etc.) can correspond to intensity map information for a pavement scanner, as described above with respect to the example subset of intensity map road survey data frames 512 and 532 of FIG. 5. Similarly, the second subset of road survey data frames included in each road survey dataset (e.g., second subset 616, second subset 636, second subset 656, etc.) can correspond to height map or relative elevation map information for a pavement scanner, as described above with respect to the example subset of height map road survey data frames 516 and 536 of FIG. 5.

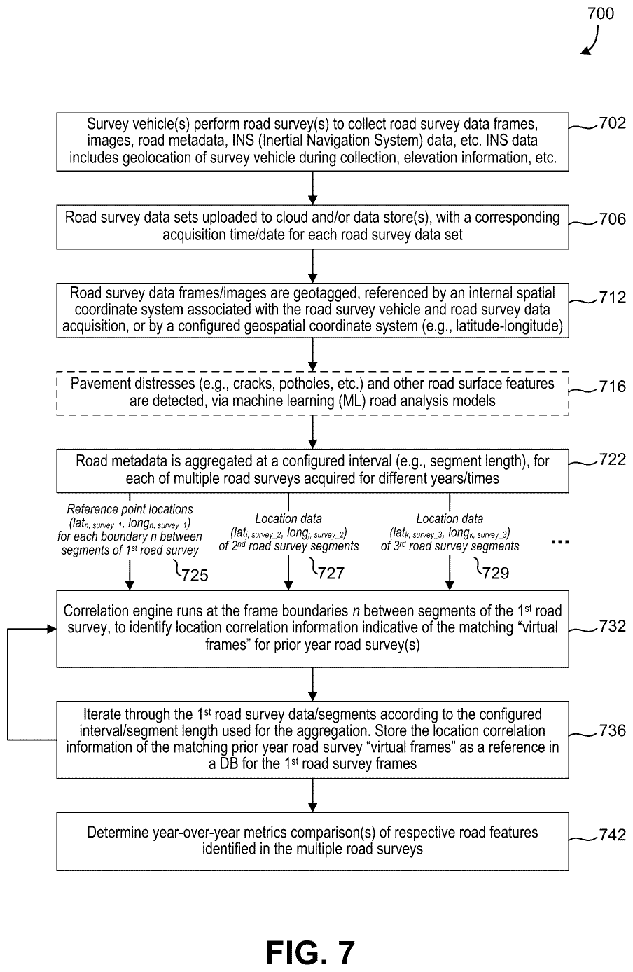

FIG. 7 is a diagram illustrating an example of a process 700 that can be used for determining and visualizing changes in road surface characteristics and/or features across location-correlated road survey data frames obtained in road surveys performed for different acquisition times and/or acquisition years, in accordance with some examples. For example, the process 700 can correspond to a process for automated year-on-year analysis for one or more calculated metrics for detected road surface features or characteristics represented in different road survey datasets obtained for different acquisition times, dates, years, etc. In some examples, the process 700 can be used to provide automated year-on-year analysis including automatic categorization of respective road survey data frames into a first category or label corresponding to a first validation result (e.g., pass, positive validation, etc.) or a second validation result (e.g., negative validation, not validated, etc.). The first and second validation results can be mapped to a need for user review or other manual intervention to confirm or validate changes between measured or detected road surface features or characteristics between different road survey datasets from different years, where the changes requiring user validation have calculated metrics that exceed one or more configured thresholds. For example, validated year-over-year results can correspond to road surface features detected for multiple road survey datasets from different years, where the derived metrics or changes in the detected features between the different road survey years are less than a threshold change amount to trigger the manual review or user intervention. The non-validated year-over-year results can be generated for road surface features detected for multiple road survey datasets from different years, where the derived metrics or changes exceed the maximum permissible change threshold or metric deviation threshold that is allowed or configured for the automated validation result. In other words, non-validated results may be generated for large changes in measured values or derived metrics for detected features that require user confirmation or validation, and are not necessarily results that are inherently invalid or incorrect.

In some aspects, the process 700 for automated year-on-year analysis can be used to generate a categorization result for each survey frame of one or more road survey collection year datasets, where the categorization result can be a “pass” result, corresponding to validating the frame as not needing an additional user review, or where the categorization result can be a “need to be reviewed” result, corresponding to flagging the frame as having a sufficiently large change in calculated values or metrics of a detected feature that exceeds the configured threshold for automated validation without user review. The categorization result of the automated year-on-year analysis of process 700 can be determined or derived based on a feature comparison at the same spatial location on the same roadway, from different road surveys collected at different respective times, dates, years, etc.

In some aspects, the process 700 can include, at block 702, one or more survey vehicle performing road surveys to collect road survey data frames and other road survey data, metadata, images, INS position information. In some aspects, block 702 of the process 700 of FIG. 7 can correspond to, and/or can be the same as or similar to, block 402 of the process 400 of FIG. 4.

At block 706, road survey data can be uploaded to a cloud repository or other database or data store(s). Block 706 of process 700 of FIG. 7 can be the same as or similar to block 406 of process 400 of FIG. 4.

At block 712, the road survey data frames can be geotagged and referenced by an internal spatial coordinate system and/or a configured geospatial coordinate system, such as a latitude-longitude coordinate system. Block 712 of the process 700 of FIG. 7 can be the same as or similar to block 412 of the process 400 of FIG. 4.

At block 716, one or more pavement distresses may optionally be detected using one or more ML or AI models, networks, systems, etc. Block 716 of the process 700 of FIG. 7 can be the same as or similar to block 416 of the process 400 of FIG. 4.

At block 722, road metadata can be aggregated at a configured interval (e.g., segment length), for each of multiple road surveys acquired at block 702 for different acquisition times, dates, years, etc. Block 722 of the process 700 of FIG. 7 may be the same as or similar to block 422 of the process 400 of FIG. 4. In one illustrative example, block 722 can be configured to determine respective reference point locations for each boundary n between the segments (e.g., road survey data frames) of the first road survey, corresponding to a first set 725 of reference point locations (e.g., (lat_{n,survey_1}, long_{n,survey_1}) for the respective top and/or bottom boundaries between the first road survey frames, for each respective frame in the first set of road survey data frames. Block 722 can additionally determine respective location data corresponding to a second set 727 of boundary location data points (e.g., (lat_{j,survey_2}, long_{j,survey_2})) between each of the j frame boundaries between consecutive road survey data frames in the second set of road survey data frames obtained at block 702. Block 722 can additionally include determining respective location data corresponding to a third set 729 of boundary location data points (e.g., (lat_{k,survey_3}, long_{k,survey_3})) between each of the k frame boundaries between consecutive road survey data frames in the third set of road survey data frames obtained at block 702.

At block 732, the correlation engine can run at the respective frame boundaries of each set of road survey data frames, corresponding to running the correlation engine at the frame boundaries indicated in the first set 725 of n frame boundaries of the first set of road survey data frames from the first time/date/year, and/or the second set 727 of j frame boundaries of the second set of road survey data frames from the second time/date/year, and/or the third set 729 of k frame boundaries of the third set of road survey data frames from the third time/date/year. In some embodiments, the correlation engine associated with block 732 of the process 700 for automated year-on-year analysis of detected road surface features or characteristics depicted in FIG. 7 can be the same as or similar to the correlation engine associated with block 432 of the process 400 for location correlation information for side-by-side visualization depicted in the example of FIG. 4 and described previously above. In some aspects, a data processing workflow associated with the process 700 for automated year-on-year analysis can include one or more workflow processing steps for determine calculated metrics for various aspects of road conditions features or characteristics over each of the respective road survey datasets obtained at block 702 for the different survey times/dates/years, etc. Block 732 can further include determining or identifying location correlation information indicative of matching virtual frames between the multiple years of road survey data, where the virtual frame matching or correlation is based on the respective frame boundary information 725, 727, and/or 729, and where the correlation is the same as or similar to the correlation implemented by the correlation engine associated with block 432 of the process 400 of FIG. 4.

At block 736, the process 700 includes iterating through the set of first road survey data frames or segments, according to the configured interval or segment length used for the aggregation at block 722. The respective location correlation information determined by the correlation engine at block 732 for the determine matching prior year road survey virtual frame information can be stored and/or output as a reference in a database or other datastore for each respective one of the first set of road survey data frames configured for the correlation baseline of the correlation engine at block 736. The process 700 can include iterating over each respective frame or frame boundary n of the first road survey dataset, where the iterating includes repeatedly performing blocks 732 and 736 of the process 700 until the correlation engine has run for the final road survey data frame or road survey frame boundary n associated with the first road survey dataset.

From block 736, the process 700 can proceed to block 742, which includes determining year-over-year (e.g., year-on-year) metrics or calculated values for comparison(s) of respective road features identified in the multiple road surveys of block 702 over the multiple different survey times/dates/years. In some examples, the year-on-year feature metrics or calculated value comparison(s) of block 736 can be performed corresponding to respective road features identified or detected according to the ML/AI road analysis models associated with the block 716 step configured to identify pavement distresses such as cracks, potholes, etc.

The year-on-year metrics comparison(s) of block 742 can correspond to determining the calculated metrics for different aspects, features or characteristics of the road condition, and automatically calculating the differences between the latest (e.g., most current) road survey data collection year/cycle, and the previous associated collection year/cycle of road survey data obtained representative of the same asset and location. Block 742 can further include automatically determining whether the metric delta is within the configured threshold maximum permissible difference year-over-year and can be validated, or if the metric delta exceeds the configured threshold maximum permissible year-over-year difference and should be flagged as requiring additional user or manual review and confirmation, etc. In some aspects, the automated year-on-year analysis of process 700 can be extended to include automatically determining one or more insights or trends of road condition feature change or progression, to thereby highlight to the user one or more detected valid changes in an asset that are outside of the expected ranges indicated by the configured maximum thresholds on the delta change between years, where the automatically highlighted valid change detections beyond the configured threshold correspond to changes in road features or characteristics that may benefit from additional attention or study in data review and follow-on asset management planning and/or remediation, etc.

In some aspects, the automated year-on-year analysis corresponding to FIG. 7 and the process 700 can be implemented given a particular geo-spatial point (e.g., longitude₁, latitude₁), where the particular geo-spatial point is used to query a geo-spatial database to determine a road survey line geometry that contains the exact point indicated by the query (e.g., a road survey line geometry containing the queried geo-spatial point (e.g., longitude₁, latitude₁)). As the road survey collection vehicle trajectory may vary from year to year across the multiple road survey datasets obtained at block 702 of the process 700 (e.g., variance within the range of several hundred centimeters within the travel lane of the vehicle, etc.), it may be unlikely that the query to the database with the particular geo-spatial point (longitude₁, latitude₁) returns an exact match of a point to another, prior road survey collection year. Accordingly, rather than trying to find a specific matching point for the queried location (longitude₁, latitude₁), which may be unlikely to exist as a surveyed point within the database of prior year road survey datasets, the systems and techniques can use the automated year-on-year analysis to search for, using the correlation engine and block 732 and/or block 736, etc., the closest point or maximum correlation point within a configured tolerance threshold. For example, the correlation engine at block 732 and/or block 736 can query the database for the closest, previously survey point(s) from prior road survey data collection years and datasets that are within a configured tolerance threshold of a maximum of 2 meter distance differential from the queried (longitude₁, latitude₁) location. In some aspects, correspondence between road survey data frames and/or images can be calculated based on the location correlation between attributed location data of each respective road survey data frame.

In one illustrative example, the data processing workflow of the process 700 of FIG. 7 can include determine, at block 742, various calculated metrics for different aspects of the road condition, and automatically calculating the differences between the latest data collection year or cycle of available road survey data from block 702, and one or multiple previous associated collection years or cycles of available road survey data of block 702 that was obtained for the same asset and location. In some embodiments, the metrics representative of road condition information determined at block 742 can correspond to pavement or road surface distress data, as noted above. The metrics and metrics delta values calculated at block 742 may additionally, or alternatively, correspond to other data beyond road distress information, such as grade of the road (e.g., corresponding to facilitation, or lack of facilitation, of water drainage from the road surface, etc.), which may be collected or measured at least in part by the road survey vehicles and the corresponding collected road survey measurement data, etc.

In some aspects, the automated year-on-year analysis corresponding to the process 700 of FIG. 7 can include one or more processing or pre-processing operations that can be applied to road survey images and/or data frames from the different survey years to apply operations such as scaling or transformations to a consistent representation across the different survey year data collections. In some embodiments, the automated year-on-year analysis may be further extended to include automated mapping of images from different road survey data collections and different acquisition times/.dates/years, based at least in part on feature-to-feature identification and mapping between the different road survey datasets and respective sets of road survey data frames thereof. For example, automatic feature-to-feature mapping can be performed to identify the maximum correlation pairs of road survey data frames across multiple road survey datasets from different years. The automatic feature-to-feature mapping can further include automatically calculating respective metrics for mapped pairs or sets of images across the different road survey collection years, and determining the magnitude or value of the difference delta across different year-to-year comparisons of different road survey data frames corresponding to the same asset at the same location.

In some embodiments, the system can automatically determine and apply one or more normalizations or normalization transforms to the respective road survey data frames prior to performing the delta calculations for road surface feature detections over multiple years. For example the collected images and frames of road survey data can vary across the multiple survey years, including variations not attributable to changes in the condition or presentation of the pavement or road surface. For instance, variation may be based on changes in orientation, lighting, etc., rather than actual physical changes in the detected road surface features or pavement distresses. The normalization can be performed and applied to compensate for such non-physical pavement feature variations that may nevertheless present as variations in the different years of road survey data frames. The calculated metrics and metrics delta can subsequently be calculated using the normalized images and road survey data frames, such that the delta of calculated metrics is majority or entirely attributable to physical changes in a detected feature or characteristics of the road or pavement surface. Normalization to compensate for changes in imaging or survey sensor data acquisition conditions can additionally correspond to improved accuracy in feature-to-feature alignment, in examples where feature-to-feature alignment is used to supplement or augment the correlation engine alignment using location correlation information.

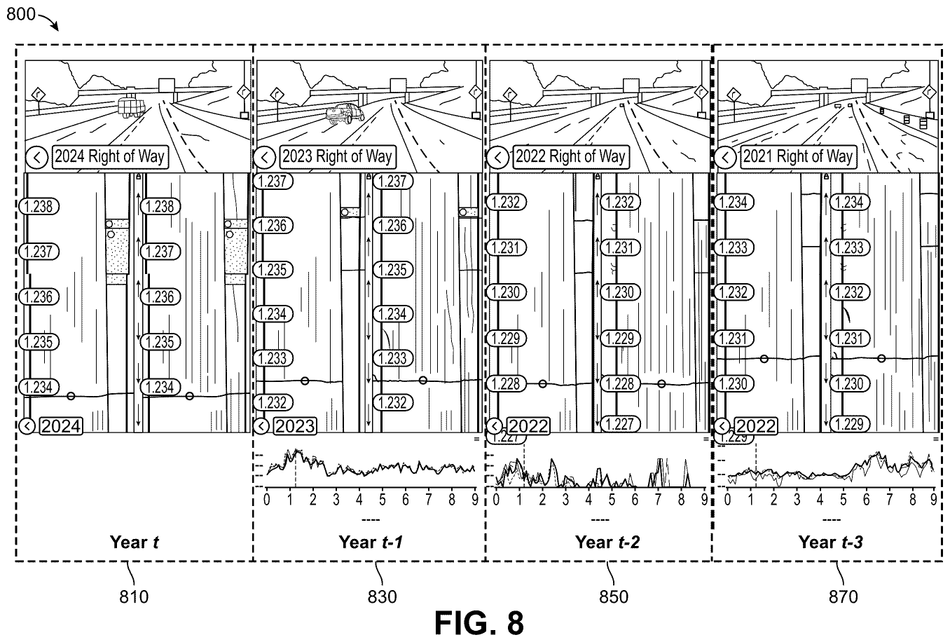

FIG. 8 illustrates an example of a multi-year correlated view 800 of road survey data frames obtained from four different road surveys performed for four different acquisition years, in accordance with some examples. For example, road survey data 810 can comprise a selected portion of road survey data frames obtained from a first road survey performed for a first acquisition date/time/year (e.g., year t), and may be the same as or similar to one or more of the first road survey data 510 of FIG. 5, the first road survey data 610 of FIG. 6, etc. A second road survey data 830 of FIG. 8 can comprise a selected portion of road survey data frames obtained from a second road survey performed for a second acquisition date/time/year (e.g., year t−1), and may be the same as or similar to one or more of the second road survey data 530 of FIG. 5, the second road survey data 630 of FIG. 6, etc. A third road survey data 850 of FIG. 8 can comprise a selected portion of road survey data frames obtained from a third road survey performed for a third acquisition date/time/year (e.g., year t−2), and may be the same as or similar to the third road survey data 650 of FIG. 6. A fourth road survey data 870 of FIG. 8 can comprise a selected portion of road survey data frames obtained from a fourth road survey performed for a fourth acquisition date/time/year (e.g., year t−3). Each of the road survey data sets 810, 830, 850, 870 can include a respective first subset of road survey data frames representing intensity map information for a pavement scanner, and can include a respective second subset of road survey data frames representing height map information for the pavement scanner, etc.

In some examples, year-on-year analysis for calculated metrics of detected or identified road features can be calculated between various pairs of road survey data years, each of which may have the same or different maximum thresholds of the delta difference before triggering manual review. For example, a one-year delta may be determined between pairs of road survey data collected for consecutive acquisition years, such as the first road survey data 810 and second road survey data 830, the second road survey data 830 and the third road survey data 850, the third road survey data 850 and the fourth road survey data 870, etc. A one year maximum delta threshold can be used for comparison to trigger or not trigger manual review of feature changes between two consecutive years. A two-year delta may be determined between pairs of road survey data collected for acquisition years that are two years apart. For example, the first road survey data 810 and the third road survey data 850, the second road survey data 830 and the fourth road survey data 870, etc. The two-year delta threshold may be the same as or different from the one-year delta threshold, etc.

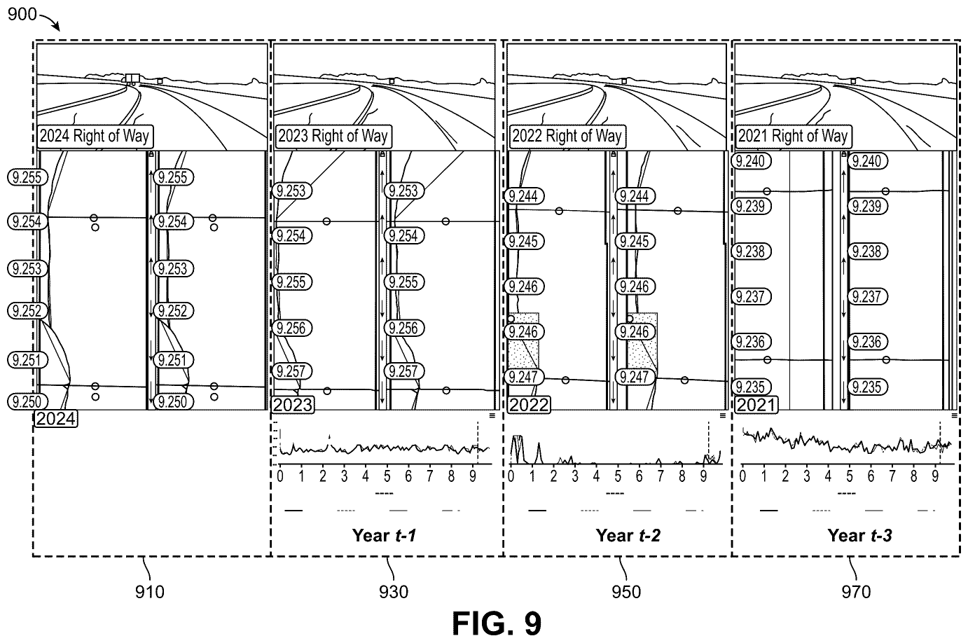

FIG. 9 illustrates another example of a multi-year correlated view 900 of road survey data frames obtained from four different road surveys performed for four different acquisition years, in accordance with some examples. For instance, a first road survey data 910 may correspond to a first road survey year t, and can be the same as or similar to the first road survey data 810 of FIG. 8. A second road survey data 930 may correspond to a second road survey year t−1, and can be the same as or similar to the second road survey data 830 of FIG. 8. A third road survey data 950 can correspond to a third road survey year t−2, and can be the same as or similar to the third road survey data 850 of FIG. 8. A fourth road survey data 970 can correspond to a fourth road survey year t−3, and may be the same as or similar to the fourth road survey data 870 of FIG. 8. Each of the road survey data sets 910, 930, 950, 970 can include a respective first subset of road survey data frames representing intensity map information for a pavement scanner, and can include a respective second subset of road survey data frames representing height map information for the pavement scanner, etc.

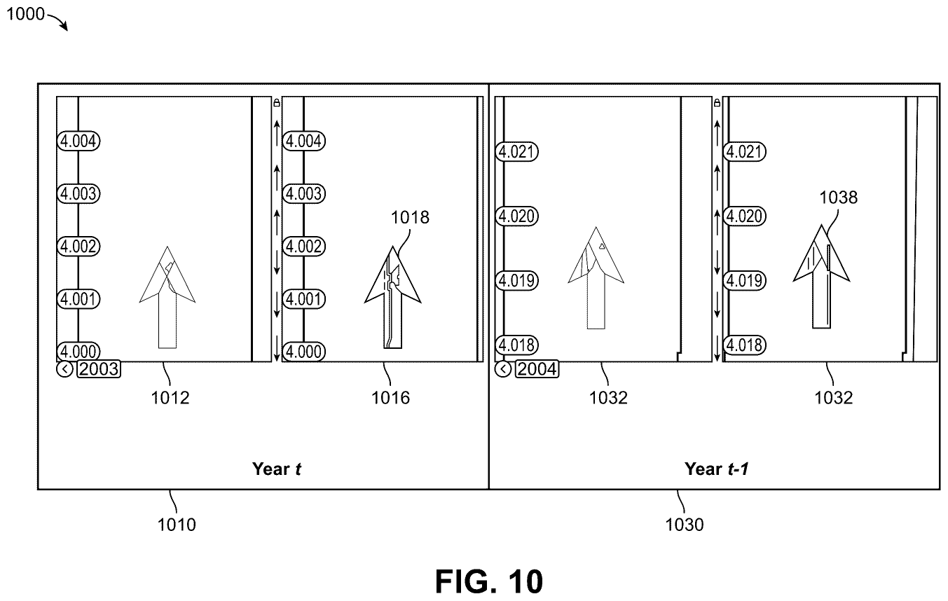

FIG. 10 illustrates an example of year-over-year road surface change analysis and visualization 1000 corresponding to a multi-year correlated view of road survey data frames obtained from a first road survey performed for a first acquisition year and a second road survey performed for a second acquisition year, in accordance with some examples. For example, a first road survey data 1010 can correspond to a first road survey year t, and may be the same as or similar to the first road survey data 810 of FIG. 8, the first road survey data 910 of FIG. 9, etc. A second road survey data 1030 can correspond to a second road survey year t−1, and may be the same as or similar to the second road survey data 830 of FIGS. 8, 930 of FIG. 9, etc. The first road survey data 1010 can include a first subset of road survey data frames 1012 and a second subset of road survey data frames 1016, which can correspond to one or more of the first subset of road survey data frames 512 and the second subset of road survey data frames 516 of FIG. 5, and/or the first subset of road survey data frames 612 and the second subset of road survey data frames 616 of FIG. 6, etc. The second road survey data 1030 can include a first subset of road survey data frames 1032 and a second subset of road survey data frames 1036, which can correspond to one or more of the first subset of road survey data frames 532 and the second subset of road survey data frames 536 of FIG. 5, and/or the first subset of road survey data frames 632 and the second subset of road survey data frames 636 of FIG. 6, etc. The first subset 1012 of the first road survey data 1010, and the first subset 1032 of the second road survey data 1030, can correspond to respective road survey data frames of pavement scanner intensity map information. The second subset 1016 of the first road survey data 1010, and the second subset 1036 of the second road survey data 1030, can correspond to respective road survey data frames of pavement scanner height map and/or relative elevation information.

In some aspects, the year t first road survey data 1010 includes, in the subset of road survey data frames 1016, a representation of a road paint asset 1018, which shows a degraded condition (e.g., larger and more extensive longitudinal cracking, etc.) relative to a previously measured condition for the same road paint asset in the earlier survey year t−1 for the second survey data 1030 and the earlier representation of the road paint asset 1038, showing less extensive and less severe longitudinal cracking of the road paint asset in the year before the year t survey in which the representation 1018 was measured. In some aspects, automated year-on-year analysis can calculate respective metrics or measurement values for the size, length, width, severity, extent, etc., of the crack or other degradation within the representation of the road paint asset 1038 for the prior year t−1 data 1030, and can additionally calculate the same respective metrics or measurement values for the size, length, width, severity, extent, etc., of the crack or other degradation within the representation of the road paint asset 1018 for the current year t data 1010. The automated year-on-year analysis can include determining a delta or other difference information between the calculated metrics for the condition or degradation of the road paint asset 1038 in the prior t−1 year representation and the current t year representation 1018. Based on the delta exceeding a configured threshold, an automated flag or alert or notification can be generated and transmitted to a user indicating a request for manual review, validation, and/or confirmation of the large delta difference beyond the threshold.

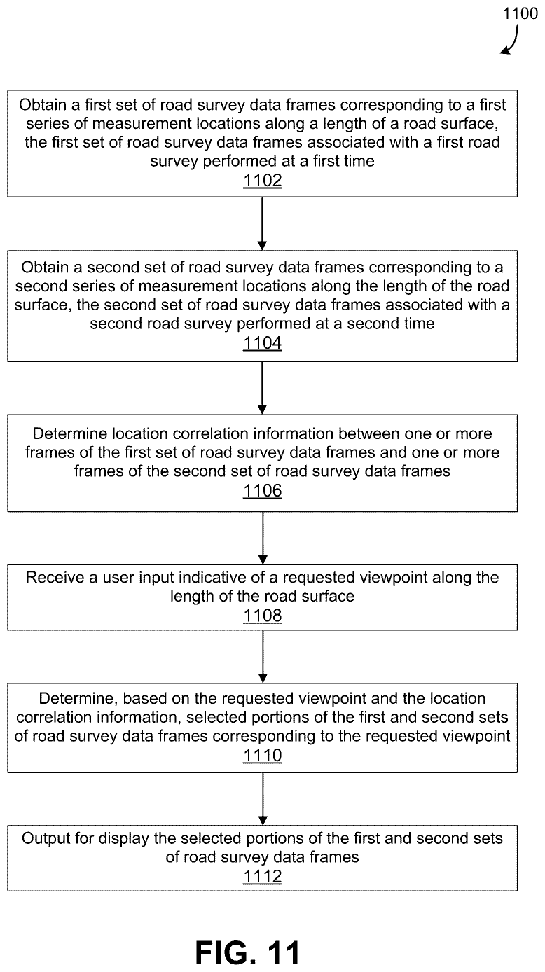

FIG. 11 is a flowchart diagram illustrating an example of a process 1100 for analyzing and/or visualizing road surveying data, including multiple sets or instances of road surveying data comprising respective sets of road survey data frames obtained for different measurement locations and acquisition times along a same length of road surface. For example, the process 1100 can correspond to analyzing and/or visualizing road survey data indicative of one or more road surface characteristics and/or features obtained from multiple road surveys performed for different acquisition times (e.g., acquisition date(s), week(s), month(s), year(s), etc.). In some aspects, the process 1100 for analyzing and/or visualizing road surveying data can be performed corresponding to one or more of the various data acquisition events, road surveys, road survey data frames, multi-year correlated views, etc., of any of FIGS. 4-10 and/or otherwise described herein. For example, the process 1100 can correspond to road surveying using automatically detected and determined corresponding start and end points for each road segment of a plurality of road segments included in a sequence of target road sections for the road survey, in accordance with some examples. In one illustrative example, the process 1100 can be implemented based on road survey data comprising a plurality of road survey data frames that are obtained by a vehicle that includes, integrated, and/or is coupled to a road surveying mechanism. For example, the process 1100 can be implemented based on road survey data frames and/or road surveying data or information obtained by a vehicle (e.g., road survey vehicle, road profiler vehicle, road profiler, etc.) that is the same as or similar to the vehicle 154 of FIGS. 2-3B, etc. In some cases, the process 1100 can be implemented using road survey data frames that are obtained by a vehicle that includes a road surveying mechanism that is the same as or similar to the road surveying mechanism 100 of FIGS. 1-3B. In some aspects, the process 1100 can be implemented to analyze and/or visualize road survey data frames obtained using the road survey system 200 of FIG. 2.

In some aspects, at block 1102, the process 1100 can include obtaining a first set of road survey data frames corresponding to a first series of measurement locations along a length of a road surface, the first set of road survey data frames associated with a first road survey performed at a first time. For example, the first set of road survey data frames can correspond to one or more of the first set of road survey data 510 of FIG. 5, the first set of road survey data 610 of FIG. 6, the first set of road survey data 810 of FIG. 8, the first set of road survey data 910 of FIG. 9, the first set of road survey data 1010 of FIG. 10, etc.

At block 1104, the process 1100 can include obtaining a second set of road survey data frames corresponding to a second series of measurement locations along the length of the road surface, the second set of road survey data frames associated with a second road survey performed at a second time. For example, the second set of road survey data frames can correspond to one or more of the second set of road survey data 530 of FIG. 5, the second set of road survey data 630 of FIG. 6, the second set of road survey data 630 of FIG. 6 (and/or the third set of road survey data 650 of FIG. 6, etc.), the second set of road survey data 830 of FIG. 8 (and/or the third set of road survey data 850, the fourth set of road survey data 870, etc., of FIG. 8), the second set of road survey data 930 of FIG. 9 (and/or the third set of road survey data 950, the fourth set of road survey data 970, etc., of FIG. 9), the second set of road survey data 1030 of FIG. 10, etc.

At block 1106, the process 1100 can include determining location correlation information between one or more frames of the first set of road survey data frames and one or more frames of the second set of road survey data frames.

For example, the location correlation information can be indicative of a plurality of mappings between the first set of road survey data frames and the second set of road survey data frames, In some cases, each mapping of the plurality of mappings is based on correlating the first series of measurement locations with the second series of measurement locations. For example, each mapping of the plurality of mappings may comprise a location reference between a respective first frame included in the first set of road survey data frames and a respective second frame included in the second set of road survey data frames. The respective second frame for each mapping can be selected from the second set of road survey data frames based on maximizing a correlation between measurement locations corresponding to the respective first and second frames.

In some cases, each respective frame of the first set of road survey frames can be associated with a respective mapping to a selected frame of the second set of road survey frames. The selected frame of the second set of road survey frames can be selected to minimize a difference in measurement location between the selected frame of the second set and the respective frame of the first set. In some examples, the location correlation information may comprise pre-determined mappings between each frame of the first set of road survey data frames to a selected frame of the second set of road survey data frames. In some embodiments, the pre-determined mappings are stored in a database, and determining the location correlation information comprises retrieving one or more of the pre-determined mappings from the database.

In some examples, the location correlation information can be associated with a configured coordinate system different from an acquisition coordinate system used for the first and second sets of road survey data frames. In some cases, determining the location correlation information includes normalizing the first and second series of measurement locations from the acquisition coordinate system to the configured coordinate system. In some examples, the location correlation information can be determined based on comparing normalized first measurement locations of the first set of road survey data frames with normalized second measurement locations of the second set of road survey data frames to identify maximum correlation pairs of data frames across the first and second sets. In some cases, the location correlation information can include a respective location correlation for each road survey data frame of the first set of road survey data frames, where the respective location correlation is indicative of a selected road survey data frame from the second set of road survey data frames with a nearest measurement location to the road survey data frame of the first set. In some examples, the location correlation information is determined based at least in part on one or more of the requested viewpoint or a portion of the user input.

At block 1108, the process 1100 can include receiving a user input indicative of a requested viewpoint along the length of the road surface. For example, the user input can be received from a user of a visualization and/or analysis application associated with viewing or analyzing road survey data frames obtained for a plurality of road surveys performed for different acquisition times and/or acquisition years. In some examples, the user input can be received from a user corresponding to and/or associated with one or more of a visualization application associated with the example multi-year correlated view 500 of FIG. 5, the example multi-year correlated view 600 of FIG. 6, the example multi-year correlated view 800 of FIG. 8, the example multi-year correlated view 900 of FIG. 9, and/or the example multi-year correlated view 1000 of FIG. 10, etc.

At block 1110, the process 1100 can include determining, based on the requested viewpoint and the location correlation information, selected portions of the first and second sets of road survey data frames corresponding to the requested viewpoint. At block 1112, the process 1100 can include outputting for display the selected portions of the first and second sets of road survey data frames. For example, the outputting for display can correspond to updating a multi-year correlated view presented by a user interface (UI) and/or graphical user interface (GUI) of a multi-year correlated view visualization and/or analysis application for road survey data across multiple acquisition years, where the update causes the UI or GUI to present the selected portions of the first and second sets of road survey data frames. In some examples, the selected portions of the first and second sets of road survey data frames corresponding to the requested viewpoint can be outputted for display by updating one or more of the example multi-year correlated view 500 of FIG. 5, the example multi-year correlated view 600 of FIG. 6, the example multi-year correlated view 800 of FIG. 8, the example multi-year correlated view 900 of FIG. 9, and/or the example multi-year correlated view 1000 of FIG. 10, etc.

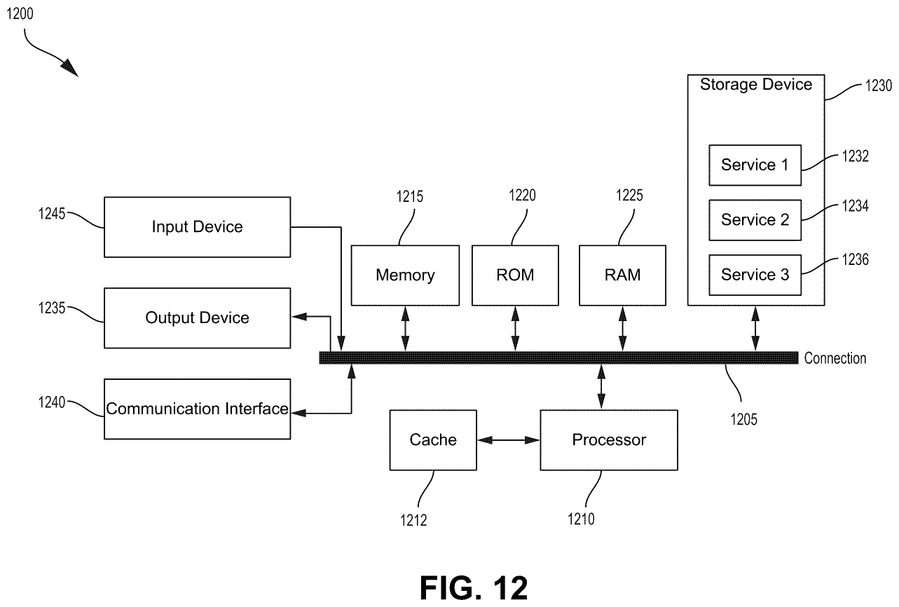

The operations of the process 1100 may be implemented as software components that are executed and run on one or more processors (e.g., processor 1210 of FIG. 12 or other processor(s)). In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1100 is illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1100 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a diagram illustrating an example of a system for implementing certain aspects of the present technology. In particular, FIG. 12 illustrates an example of computing system 1200, which may be for example any computing device making up internal computing system, a remote computing system, a camera, or any component thereof in which the components of the system are in communication with each other using connection 1205. Connection 1205 may be a physical connection using a bus, or a direct connection into processor 1210, such as in a chipset architecture. Connection 1205 may also be a virtual connection, networked connection, or logical connection.

In some aspects, computing system 1200 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 may include a cache 1215 of high-speed memory connected directly with, in close proximity to, or integrated as part of processor 1210.

Processor 1210 may include any general-purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which may represent any number of input mechanisms, such as a microphone for speech, a touch-sensitive screen for gesture or graphical input, keyboard, mouse, motion input, speech, etc. Computing system 1200 may also include output device 1235, which may be one or more of a number of output mechanisms. In some instances, multimodal systems may enable a user to provide multiple types of input/output to communicate with computing system 1200.

Computing system 1200 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210, it causes the system to perform a function. In some aspects, a hardware service that performs a particular function may include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“>”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

1. A method comprising:
obtaining a first set of road survey data frames corresponding to a first series of measurement locations along a length of a road surface, the first set of road survey data frames associated with a first road survey performed at a first time;
obtaining a second set of road survey data frames corresponding to a second series of measurement locations along the length of the road surface, the second set of road survey data frames associated with a second road survey performed at a second time;
determining location correlation information between one or more frames of the first set of road survey data frames and one or more frames of the second set of road survey data frames;
receiving a user input indicative of a requested viewpoint along the length of the road surface;
determining, based on the requested viewpoint and the location correlation information, selected portions of the first and second sets of road survey data frames corresponding to the requested viewpoint; and
outputting for display the selected portions of the first and second sets of road survey data frames.

2. The method of claim 1, wherein the location correlation information is indicative of a plurality of mappings between the first set of road survey data frames and the second set of road survey data frames, and wherein each mapping of the plurality of mappings is based on correlating the first series of measurement locations with the second series of measurement locations.

3. The method of claim 2, wherein:
each mapping of the plurality of mappings comprises a location reference between a respective first frame included in the first set of road survey data frames and a respective second frame included in the second set of road survey data frames; and
the respective second frame for each mapping is selected from the second set of road survey data frames based on maximizing a correlation between measurement locations corresponding to the respective first and second frames.

4. The method of claim 2, wherein:
each respective frame of the first set of road survey frames is associated with a respective mapping to a selected frame of the second set of road survey frames; and
the selected frame of the second set of road survey frames is selected to minimize a difference in measurement location between the selected frame of the second set and the respective frame of the first set.

5. The method of claim 2, wherein:
the location correlation information comprises pre-determined mappings between each frame of the first set of road survey data frames to a selected frame of the second set of road survey data frames;
the pre-determined mappings are stored in a database; and
determining the location correlation information comprises retrieving one or more of the pre-determined mappings from the database.

6. The method of claim 1, wherein:
the location correlation information is associated with a configured coordinate system different from an acquisition coordinate system used for the first and second sets of road survey data frames; and
determining the location correlation information includes normalizing the first and second series of measurement locations from the acquisition coordinate system to the configured coordinate system.

7. The method of claim 6, wherein the location correlation information is determined based on comparing normalized first measurement locations of the first set of road survey data frames with normalized second measurement locations of the second set of road survey data frames to identify maximum correlation pairs of data frames across the first and second sets.

8. The method of claim 1, wherein:
the location correlation information includes a respective location correlation for each road survey data frame of the first set of road survey data frames, the respective location correlation indicative of a selected road survey data frame from the second set of road survey data frames with a nearest measurement location to the road survey data frame of the first set.

9. The method of claim 1, wherein the outputting for display comprises:
outputting a simultaneous side by side view of the selected portion of the first set of road survey data frames and the selected portion of the second set of road survey data frames,
wherein the selected portion of the first set of road survey data frames is aligned to the requested viewpoint based on the location correlation information, and wherein the selected portion of the second set of road survey data frames is aligned to the requested viewpoint based on the location correlation information.

10. The method of claim 1, wherein the location correlation information is determined based at least in part on one or more of the requested viewpoint or a portion of the user input.

11. A method comprising:
obtaining a first set of road survey data frames corresponding to a first series of measurement locations along a length of a road surface, the first set of road survey data frames associated with a first road survey performed at a first time;
obtaining a second set of road survey data frames corresponding to a second series of measurement locations along the length of the road surface, the second set of road survey data frames associated with a second road survey performed at a second time; and
determining location correlation information between the first set of road survey data frames and the second set of road survey data frames, wherein the location correlation information is indicative of a plurality of mappings between respective frames of the first set and respective frames of the second set according to correlations calculated for the first and second series of measurement locations.

12. The method of claim 11, wherein the first set of road survey data frames include measurements indicative of a first set of road features corresponding to characteristics of the road surface at the first time, and wherein the second set of road survey data frames include measurements indicative of a second set of road features corresponding to characteristics of the road surface at the second time.

13. The method of claim 12, further comprising:
identifying, within a first frame of the first set of road survey data frames, a first representation of a particular feature from the first set of road features;
identifying, within a selected frame included in the second set of road survey data frames and mapped to the first frame based on the location correlation information, a second representation of the particular feature, the second representation included in the second set of road features; and
comparing the first representation with the second representation to determine feature difference information between the first road survey and the second road survey.

14. The method of claim 12, wherein the location correlation information is determined based on minimizing an alignment difference between a first representation of a particular feature from the first set of road features and a second representation of the particular feature included in the second set of road features.

15. The method of claim 13, further comprising:
validating the location correlation information based on the feature difference information being within a configured threshold.

16. The method of claim 13, further comprising:
determining the feature difference information exceeds a configured threshold; and
generating a notification indicative of a request for user review to validate or invalidate one or more of the location correlation information or the feature difference information.

17. The method of claim 11, further comprising:
determining one or more shared road features included in the first set of road features and the second set of road features;
for each shared road feature of the one or more shared road features, calculating first feature metrics for representations of the shared road feature in the first set of road survey data frames, and calculating second feature metrics for representations of the shared road feature in the second set of road survey data frames; and
generating information indicative of one or more feature changes between the first road survey at the first time and the second road survey at the second time, the one or more feature changes based on a difference between the calculated first and second feature metrics.

18. An apparatus comprising:
at least one memory; and
at least one processor coupled to the at least one memory and configured to:
obtain a first set of road survey data frames corresponding to a first series of measurement locations along a length of a road surface, the first set of road survey data frames associated with a first road survey performed at a first time;
obtain a second set of road survey data frames corresponding to a second series of measurement locations along the length of the road surface, the second set of road survey data frames associated with a second road survey performed at a second time;
determine location correlation information between one or more frames of the first set of road survey data frames and one or more frames of the second set of road survey data frames;
receive a user input indicative of a requested viewpoint along the length of the road surface;
determine, based on the requested viewpoint and the location correlation information, selected portions of the first and second sets of road survey data frames corresponding to the requested viewpoint; and
output for display the selected portions of the first and second sets of road survey data frames.

19. An apparatus comprising:
at least one memory; and
at least one processor coupled to the at least one memory and configured to:
obtain a first set of road survey data frames corresponding to a first series of measurement locations along a length of a road surface, the first set of road survey data frames associated with a first road survey performed at a first time;
obtain a second set of road survey data frames corresponding to a second series of measurement locations along the length of the road surface, the second set of road survey data frames associated with a second road survey performed at a second time; and
determine location correlation information between the first set of road survey data frames and the second set of road survey data frames, wherein the location correlation information is indicative of a plurality of mappings between respective frames of the first set and respective frames of the second set according to correlations calculated for the first and second series of measurement locations.
